(19) United States
(12) Patent Application Publication
(10) Pub. No.: US 2021/0383634 A1
(43) Pub. Date: Dec. 9, 2021

(54) MONEY HANDLING APPARATUS AND MONEY HANDLING METHOD

(71) Applicant: Glory Ltd., Himeji-shi (JP)

(72) Inventors: Satoru KOBAYASHI, Himeji-shi (JP); Yang CHEN, Himeji-shi (JP); Kazuhiro DOI, Himeji-shi (JP)

(73) Assignee: Glory Ltd., Himeji-shi (JP)

(21) Appl. No.: 17/336,304

(22) Filed: Jun. 2, 2021

(30) Foreign Application Priority Data
Jun. 3, 2020 (JP) 2020-097185

(51) Int. Cl. G07D 11/24; G07D 11/34

(52) U.S. Cl. CPC G07D 11/24; G07D 11/12; G07D 11/34

(57) ABSTRACT

A money handling apparatus includes a receptacle that receives money; a plurality of storage units; a collection unit; and control circuitry. Each storage unit stores the money and feeds out the stored money. The collection unit stores money in a container, the container being detachably mounted to the collection unit. The control circuitry is configured to control storage of collection target money, which is to be collected and removed from the money handling apparatus, in the container and at least one storage unit of the plurality of storage units.

### CROSS-REFERENCE TO RELATED APPLICATION

The present application is a continuation of and claims priority to Japanese Patent Application No. 2020-097185 filed on Jun. 3, 2020, the entire contents of which is incorporated herein by reference.

### TECHNICAL FIELD

The present disclosure relates to a money handling apparatus and a money handling method.

### BACKGROUND

Conventionally, banknote handling apparatuses for handling money have been used in various places, such as in a store or other commercial place of business. The banknote handling apparatus recognizes deposited banknotes, and stores the banknotes for each denomination into a plurality of storage units in the apparatus. The banknote handling apparatus is provided with a detachable collection cassette. The collection cassette is used as a container for collecting banknotes. When there are banknotes to be collected from the banknote handling apparatus, these banknotes are fed out from the storage units and stored in the collection cassette.

The banknote handling apparatus includes a safe in which the storage units and the collection cassette are disposed. The safe ensures security even when a large number of banknotes are stored in the apparatus. For example, the store keeps, in the collection cassette, banknotes that are proceeds from sales to be collected from the store to a bank. The store requests a cash-in-transit (CIT) company for transport of the proceeds from sales, from the store to the bank. A person in charge of the CIT company opens the door of the safe of the banknote handling apparatus, takes out the collection cassette in which banknotes as the proceeds from sales are stored, and transports the collection cassette with the proceeds from sales to the bank.

### SUMMARY

An aspect of the present disclosure relates to a money handling apparatus including a receptacle that receives money; a plurality of storage units; a collection unit; and control circuitry. Each storage unit stores the money and feeds out the stored money. The collection unit stores money in a container, the container being detachably mounted to the collection unit. The control circuitry is configured to control storage of collection target money, which is to be collected and removed from the money handling apparatus, in the container and at least one storage unit of the plurality of storage units.

### BRIEF DESCRIPTION OF THE DRAWINGS

FIGS. 1A to 1C are schematic diagrams illustrating an outline of a banknote handling apparatus according to an embodiment;

FIG. 2 is a cross-sectional view schematically showing an internal configuration of the banknote handling apparatus;

FIG. 3 is a block diagram schematically showing a functional configuration of the banknote handling apparatus;

FIG. 4 is a schematic diagram illustrating a depositing process performed in the banknote handling apparatus;

FIG. 5 is a schematic diagram illustrating a dispensing process performed in the banknote handling apparatus;

FIGS. 6A and 6B are schematic diagrams illustrating an inventory confirmation process performed in the banknote handling apparatus;

FIGS. 7A to 7C are schematic diagrams illustrating movement of banknotes during a collection process performed in the banknote handling apparatus;

FIGS. 8A to 8D are schematic diagrams illustrating an example of a banknote handling process performed in the banknote handling apparatus;

FIG. 9 is a schematic diagram illustrating an example of a banknote handling process in which some storage units are used for only collection of banknotes;

FIGS. 10A and 10B are schematic diagrams illustrating an example of a banknote handling process in which some storage units are used for only an inventory confirmation process;

FIGS. 11A and 11B are schematic diagrams illustrating a container collection process performed in the banknote handling apparatus;

FIGS. 12A to 12C show examples of screens of an operation unit during the container collection process;

FIGS. 13A to 13D are schematic diagrams illustrating a first method in which collection target banknotes in a storage unit are transported to an inventory confirmation storage unit and thereafter collected into a collection container;

FIGS. 14A to 14D are schematic diagrams illustrating a second method in which collection target banknotes are directly collected from a storage unit into a collection container;

FIGS. 15A and 15B show examples of screens indicating banknote information displayed on the operation unit;

FIGS. 16A and 16B are schematic diagrams illustrating a banknote management method using serial numbers;

FIG. 17 is a diagram for describing the property right to banknotes;

FIG. 18 is a cross-sectional view schematically showing another configuration of the banknote handling apparatus; and

FIG. 19 is a block diagram of processing circuitry that performs computer-based operations in accordance with the present disclosure.

### DETAILED DESCRIPTION OF THE DRAWINGS

With conventional money handling systems, a clerk, who has requested the CIT company for transport of the proceeds from sales, starts a process of storing money of the proceeds from sales into the collection cassette inside the money handling apparatus. If the collection cassette has become full of money in the middle of the process, the process is suspended. The clerk cannot use the money handling apparatus in the suspended state. No clerk can use the money handling apparatus for other money handing processes until the suspended process of storing the proceeds from sales is resumed and finished. The state where the clerks cannot use the money handling apparatus persists until the person in charge of the CIT company, who has arrived at the store, dismounts the collection cassette being full of money, mounts another collection cassette to resume the suspended process for collecting the remaining money of proceeds from sales, and the resumed process is finished. In order to avoid such an undesirable situation, the clerk has to pay enough attention to money inside money handling apparatus so that the quantity of money as the proceeds from sales stored in the collection cassette does not exceed the maximum quantity of money storable in the collection cassette.

The inventors of the present disclosure have developed technology that addresses this problem of conventional money handling systems. In particular, methods and devices in accordance with the present disclosure address this problem because, even when the quantity of money to be collected from the apparatus exceeds the storage capacity of a collection container inside the apparatus, use of the money handling apparatus may be continued while keeping the money therein.

Hereinafter, an embodiment of a money handling apparatus and a money handling method according to the present disclosure will be described with reference to the accompanying drawings. The money handling apparatus handles at least either banknotes or coins. In this embodiment, examples in which the money handling apparatus is a banknote handling apparatus for handling banknotes are described; however, the following description of the banknote handling apparatus is applicable to various money handling apparatuses including a coin handling apparatus for handling coins.

[Configuration of Banknote Handling Apparatus]

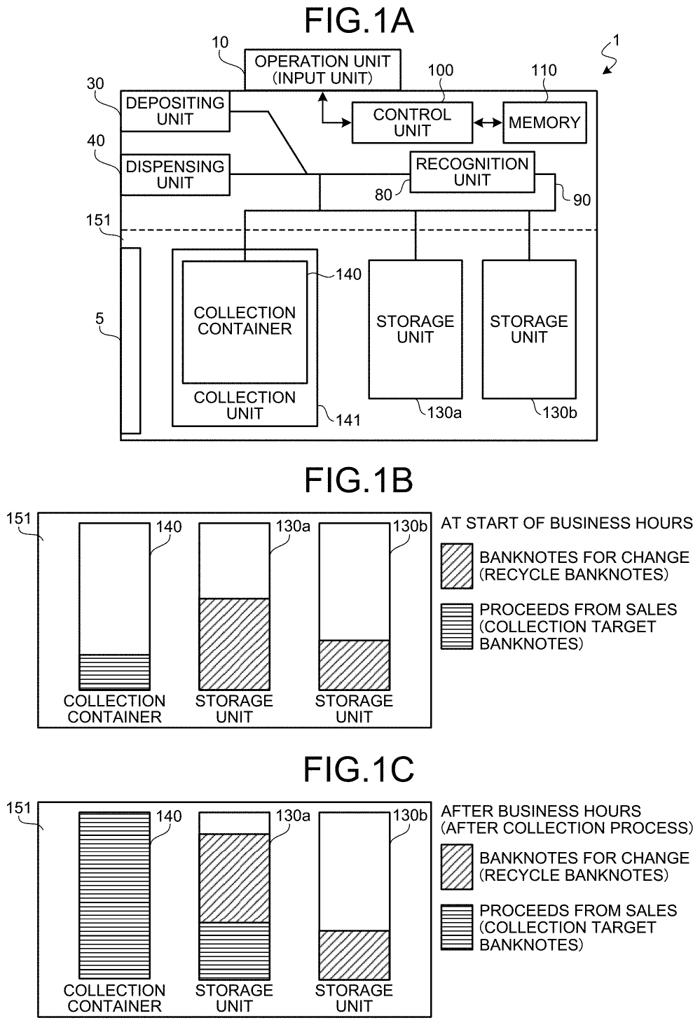

FIGS. 1A to 1C are schematic diagrams illustrating an outline of a banknote handling apparatus (money handling apparatus) 1 according to the present embodiment. FIG. 1A schematically shows an internal configuration and a functional configuration of the banknote handling apparatus 1. FIGS. 1B and 1C illustrate a banknote handling process performed by the banknote handling apparatus 1.

The banknote handling apparatus 1 may include a metallic safe unit 151. The banknote handling apparatus 1 include a plurality of storage units 130 (130a, 130b) and a collection unit 141. The plurality of storage units 130 and the collection unit 141 may be disposed in the safe unit 151. The collection unit 141 has a collection container 140 detachably mounted thereto. The collection unit 141 can store, into the collection container 140, at least a part of banknotes being stored in the banknote handling apparatus 1. For example, the banknotes in the collection container 140 are proceeds from sales of a store and are to be collected from the store by a CIT company.

The safe unit 151 has a metallic safe door 5 that is lockable and unlockable. The safe door 5 is usually locked, so that banknotes in the storage units 130 and the collection container 140 cannot be taken out from the safe unit 151. When the locked safe door 5 is unlocked with a predetermined key and opened, the banknotes in the storage units 130 and the collection container 140 can be taken out from the safe unit 151, i.e., from the banknote handling apparatus 1. Security of the banknotes is ensured since the storage units 130 and the collection container 140, which are used for storing a large quantity of banknotes, are disposed inside the safe unit 151.

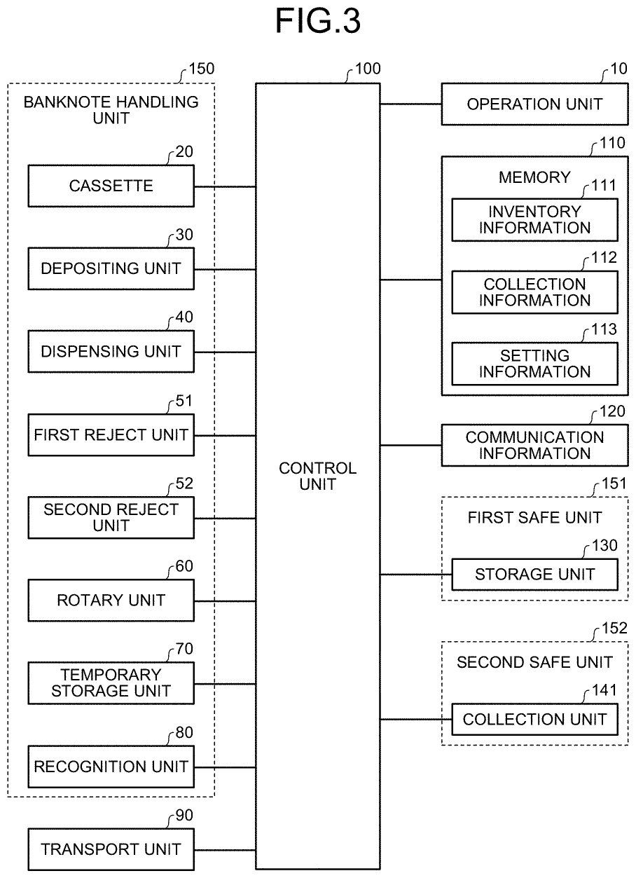

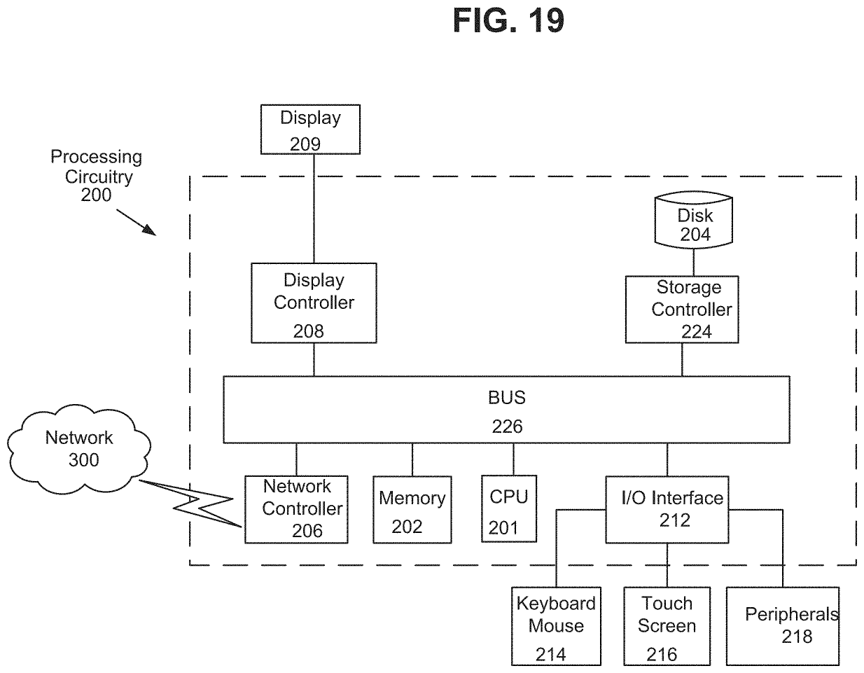

The recognition unit 80 includes various types of sensors such as an image sensor, an ultrasonic sensor, and a magnetic sensor. The recognition unit 80 can acquire recognition data for recognizing the kind of each banknote by using these sensors. The recognition data includes, for example, data for recognizing the denomination, authenticity, and fitness of each banknote. The recognition unit 80 can transmit the acquired recognition data to a control unit 100. Control unit 100 will be discussed in more detail below with respect to FIGS. 3 and 19.

A transport unit 90 includes: a transport mechanism having rollers and/or belts for transporting banknotes along a transport path; and a diversion mechanism for changing the banknote transporting direction at diverting points disposed on the transport path. The control unit 100 can control the transport mechanism and the diversion mechanism to transport banknotes along the transport path connecting each unit inside the apparatus 1. The transport unit 90 can transport banknotes between units including a depositing unit 30, a dispensing unit 40, and the recognition unit 80, and the storage units 130 and the collection container 140. The transport unit 90 can transport banknotes between the units disposed outside the safe unit 151 and the units disposed outside the safe unit 151.

Each storage unit 130 may include a stacking mechanism for stacking banknotes. The control unit 100 can control the stacking mechanism to stack the banknotes, which have been transported along the transport path, in the storage unit 130 such that the faces thereof become substantially parallel. Each storage unit 130 may further include a feeding mechanism, which may include a plurality of rollers, for feeding out banknotes from the storage unit 130. The control unit 100 can control the feeding mechanism to feed out the banknotes stacked in the storage unit 130, in order from an uppermost banknote, to the transport path connected to the storage unit 130.

The banknote handling apparatus 1 may include an operation unit 10 that can be used as an input unit. The operation unit 10 is, for example, a touch panel type liquid crystal display device. The operation unit 10 may function as an input unit and a display unit. In other implementations, operation unit 10 may include a keyboard or other input hardware. An operator of the banknote handling apparatus 1 can perform, with the operation unit 10, operations such as: confirmation of information on banknotes stored in the banknote handling apparatus 1; confirmation and update of information on settings of a banknote handling processes; and instruction on the banknote handling processes. The control unit 100 can receive the information inputted through the operation unit 10.

The operator can set, for each storage unit 130, information on the kind of banknotes to be stored therein, by operating the operation unit 10. The control unit 100 can associate the information on the kind of banknotes inputted through the operation unit 10 by the operator, with information on the storage unit 130. The control unit 100 can store, in a memory 110, information on the relationship between the kinds of banknotes and each of the storage units 130. The control unit 100 can control the depositing unit 30, the recognition unit 80, the transport unit 90, and the storage units 130, based on the information stored in the memory 110, to store banknotes, which are received by the depositing unit 30, in the corresponding one among the plurality of storage units 130.

The kinds of banknotes to be recognized in the banknote handling apparatus 1 include denomination. The kinds of banknotes may include at least one of fitness and authenticity, in addition to the denomination. The kinds of banknotes may further include information on a currency such as Canadian dollar, US dollar, Mexican peso, or Euro.

Operations that can be performed on the operation unit 10 include: a depositing operation of inputting information necessary for a depositing process of transporting deposited banknotes from the depositing unit 30 to the storage unit 130; a dispensing operation of inputting information necessary for a dispensing process of transporting banknotes, which are to be discharged to outside the apparatus 1, from the storage unit 130 to the dispensing unit 40; a collection operation of inputting information necessary for a collection process of transporting banknotes, which are to be collected into the collection container 140, from the storage unit 130 to the collection unit 141; and a container collection operation of inputting information necessary for a container collection process of dismounting the collection container 140, in which banknotes to be collected to outside the banknote handling apparatus 1 have been stored, from the apparatus 1.

Each storage unit 130 may be detachably mounted to the banknote handling apparatus 1. For example, the storage unit 130 may be detachably disposed on a frame that is movable in one direction (for example, the left-right direction in FIG. 1A) of the banknote handling apparatus 1. The safe door 5 disposed at the one side surface of the banknote handling apparatus 1 is opened, and the frame is drawn out toward the opened surface side of the apparatus 1 to outside the safe unit 151, whereby the storage unit 130 can be mounted/dismounted with respect to the frame. Although FIG. 1A shows two storage units 130a, 130b for storing banknotes in a stacking state, the storing method and the number of storage units 130 are not particularly limited. For example, the storage unit 130 may be a tape-type storage unit in which banknotes are stored by being held between tapes and wound around a drum together with the tapes.

The collection unit 141 disposed in the safe unit 151 may include: a stacking mechanism for stacking, in the collection container 140, banknotes having been transported by the transport unit 90; and a storage mechanism for storing the banknotes stacked by the stacking mechanism into the collection container 140; and a driving unit for driving the stacking mechanism and/or the storage mechanism. For example, the storage mechanism includes a lever for pushing the banknotes stacked by the stacking mechanism into the collection container 140, and the driving unit drives the lever. The collection unit 141 may be disposed on a frame that is movable in one direction (for example, the left-right direction in FIG. 1A) of the banknote handling apparatus 1.

The collection container 140 is detachably mounted to the banknote handling apparatus 1. For example, the safe door 5 disposed at one side surface of the banknote handling apparatus 1 is opened, and the frame on which the collection unit 141 is disposed is drawn out toward the opened surface side of the apparatus 1 to outside the safe unit 151, whereby the collection container 140 can be set and removed with respect to the collection unit 141.

The collection container 140 may be a bag for storing banknotes, which are to be collected to outside the apparatus 1, therein. However, types of the collection container 140 is not particularly limited. The collection container 140 may be a cassette. The cassette may include: a container part; a lid that is opened and closed when banknotes in the container part are taken out; and a lock mechanism that locks the lid in the closed state so that only a person who can open the lock mechanism can take out the banknotes from the container part. When the collection container 140 is such a cassette, the cassette may include a storage mechanism. The storage mechanism may include a stage for supporting banknotes and a plurality of rollers, so that the banknotes that have been transported by the transport unit 90 are stored in the container part by the storage mechanism.

As shown in FIG. 1A, the banknote handling apparatus 1 includes the control unit 100 and the memory 110. The control unit 100 may be called a controller, a circuit, a processor, or a computer device. The memory 110 is a non-volatile memory device. The memory 110 can store inventory information, collection information, and setting information. The inventory information can include: information on the denominations of banknotes stored in the respective storage units 130, and the number and the amount of the banknotes for each denomination in the respective storage units 130; and information on the denominations of banknotes stored in the collection container 140, and the number and the amount of the banknotes for each denomination in the collection container 140. The collection information can include: information on the denominations of banknotes to be collected from the apparatus 1, and the number and the amount of the banknotes for each denomination; and information on each place where the banknotes to be collected are being stored. The setting information can include: information on the kinds of banknotes to be stored in the respective storage units 130; and information on the contents of banknote handling processes to be performed in the banknote handling apparatus 1. The operator can display at least a part of information included in the inventory information, the collection information, and the setting information, on the screen of the operation unit 10, by operating the operation unit 10. The operator can confirm and update the setting information stored in the memory 110 by operating the operation unit 10.

The control unit 100 can control the respective components shown in FIG. 1 based on the operation performed by using the operation unit 10 while using the various kinds of information stored in the memory 110. The control unit 100 can recognize the kind of each banknote processed inside the apparatus 1, based on the recognition data acquired by the recognition unit 80. For example, the denomination of each banknote is recognized. Furthermore, the control unit 100 can count the number of banknotes for each kind, based on the recognition data acquired by the recognition unit 80. For example, the number of banknotes is counted for each kind. The control unit 100 can store information on each banknote and information on the number of banknotes for each kind in the memory 110, as inventory information and/or collection information.

The control unit 100 can control the respective components such that the functions and operations of the banknote handling apparatus 1 described in the present embodiment are implemented. For example, based on the information inputted through the operation unit 10, the banknote handling apparatus 1 can perform various banknote handling processes. The description will be continued for the case where the banknote handling apparatus 1 is used in a store.

The banknote handling apparatus 1 may further include a communication unit. The control unit 100 can control the communication unit to exchange information with an external device. The communication unit may be communicably connected to the external device via a network such as a LAN, a WAN, or the Internet. For example, if the collection container 140 in which banknotes have been stored needs to be dismounted from the banknote handling apparatus 1 and collected to outside the store, the control unit 100 can control the communication unit to transmit information for requesting the collection of the collection container 140 to a communication terminal (external device) installed in the CIT company. For another example, the external device communicating with the communication unit may be a communication terminal installed inside the store. In this case, the control unit 100 may transmit the information for requesting the collection of the collection container 140 to the communication terminal installed in the CIT company via the communication terminal installed in the store. These communication terminals may be called computer devices.

[Collection Process]

A store clerk can perform a collection process by operating the operation unit 10. In the collection process, banknotes equivalent to the proceeds from sales of the store on that day are regarded as banknotes to be collected (hereinafter referred to as “collection target banknotes”). The collection process may include a process of storing collection target banknotes fed out from the storage unit 130 into the collection container 140. The collection process may include a process of storing, in the memory 110, information on the amount of the collection target banknotes collected in the collection container 140, as information on the proceeds from sales of that day.

In the banknote handling apparatus 1, even after the number of collection target banknotes exceeds the maximum number of banknotes storable in the collection container 140, collection target banknotes, which cannot be stored in the collection container 140, can be stored in at least one storage unit 130 that is disposed inside the apparatus 1 and is provided separately from the collection container 140. The collection process of the banknote handling apparatus 1 may include a process in which the amount of collection target banknotes, which cannot be transported from one or more storage units 130 to the collection container 140 because the collection container 140 becomes full of banknotes in the middle of the collection process, is recorded as the proceeds from sales while leaving these collection target banknotes in the storage units 130. In this case, the information on the proceeds from sales in the memory 110 includes: information on the amount of the collection target banknotes which has been collected from the storage units 130 and are being stored in the collection container 140; information on the storage units 130 in which the collection target banknotes are left therein after the collection process; and information on the amount of these collection target banknotes which are being stored in the storage units 130 but whose amounts are recorded as the proceeds from sales.

If the collection container 140 has been already full of banknotes before starting the collection process, the collection process may include a process in which the amount of collection target banknotes being stored in one or more storage units 130 is recorded as proceeds from sales. In this case, the information on the proceeds from sales in the memory 110 includes: information on the storage units 130 in which the collection target banknotes are being stored; and information on the amount of these collection target banknotes recorded as the proceeds from sales.

In the banknote handling apparatus 1, the information on the proceeds from sales can be managed in the collection information stored in the memory 110. The information on the proceeds from sales may include information on the storage places of the collection target banknotes whose amounts are recorded as the proceeds from sales, and information on the amount of the collection target banknotes in each storage place. The “storage place” is information on the place where the collection target banknotes, whose information is registered in the collection information in the memory 110, are stored. In the banknote handling apparatus 1, even after the collection container 140 has become full of banknotes, collection target banknotes can be kept inside the apparatus 1 by storing them in at least one of the storage units 130. Therefore, the “storage place” may include only the collection container 140, or the collection container 140 and one or more storage units 130.

When the number of collection target banknotes stored in the storage unit 130 becomes equal to or greater than a predetermined number prepared in the memory 110 in advance, the control unit 100 can determine that collection of banknotes by a CIT company is necessary. The control unit 100 can transmit information indicating that the collection of banknotes is necessary, from the communication unit to the communication terminal (external device) used by the CIT company.

The clerk can operate the operation unit 10 to input information needed for the collection process, whereby the control unit 100 starts the collection process. When the collection process has started, the collection target banknotes stored in the storage unit 130 are fed out and stored in the collection container 140. The banknotes are fed out, one by one, from each storage unit 130 to the transport path sequentially. The collection target banknotes are transported to the collection unit 141 by the transport unit 90, and stored in the collection container 140 in the collection unit 141.

The recognition unit 80 acquires recognition data of each banknote fed out from the storage unit 130 to the transport path. The control unit 100 can recognize the kinds of the banknotes stored in the collection container 140 based on the recognition data. The control unit 100 can counts the number of these stored banknotes.

The control unit 100 can store the counting result in the collection information in the memory 110. After the collection container 140 has become full of banknotes, the control unit 100 can use the storage unit 130 for storage of remaining collection target banknotes. Hereinafter, two examples of the banknote handling process using the storage unit 130 for storage of collection target banknotes will be described.

[Example 1 of Banknote Handling Process of Storing Collection Target Banknotes in Storage Unit]

FIG. 1B is a schematic diagram illustrating an example of the banknote handling process performed in the banknote handling apparatus 1. In FIG. 1B, since the banknote storage states in the storage unit 130 and the collection container 140 are to be described, only the components necessary for the description are schematically shown while the other components are omitted but shown in other drawings.

In the banknote handling apparatus 1, each of the storage units 130 can be assigned a denomination of banknotes to be stored therein, in advance. The number of banknotes, which are to be stored in each storage unit 130 and are to be used as change in the store, can also be set for each denomination in advance. Information of the denominations assigned to the respective storage units 130 and information of the number of banknotes for change for each denomination can be stored in the setting information in the memory 110 in advance.

As shown in FIG. 1B, banknotes for change, of which the denominations and the number for each denomination have been set in advance as change fund, are stored in the storage units 130 corresponding to the denominations of the change fund before business hours of the store business. In the collection container 140, collection target banknotes may be stored. For example, banknotes equivalent to an amount obtained by subtracting the amount of change fund for one business day from the amount of proceeds from sales on the previous day may be stored in the collection container 140.

During the business hours of the store, a dispensing process and a depositing process are performed in the banknote handling apparatus 1. A store clerk can perform, with the banknote handling apparatus 1, a process of dispensing banknotes for change to be used to return to a customer for transactions in the store. In the dispensing process, the banknotes are fed out from the storage units 130 and discharged from the banknote handling apparatus 1. The clerk can perform a process of depositing banknotes, which may be processed as proceeds from sales of the store, received from a customer. In the depositing process, the banknotes received in the depositing units 30 are fed out to the transport path and stored in the storage unit 130 inside the banknote handling apparatus 1. The banknote handling apparatus 1 can perform recycling of a banknote, that is, a process in which a banknote having been stored in the storage unit 130 in the depositing process is fed out from the storage unit 130 and dispensed in the dispensing process.

Out of the banknotes deposited in the depositing process, a banknote that is determined by the control unit 100 not to be dispensable can be stored in the collection container 140. In addition, a banknote which can be deposited in the banknote handling apparatus 1 but the denomination of which is not assigned to the storage units 130, and a banknote which is to be stored in the storage unit 130 but cannot be stored because the storage unit 130 is full, can be stored in the collection container 140. The collection container 140 is used for storage of banknotes to be collected to outside the apparatus 1, and the banknotes in the collection container 140 are not used for the dispensing process.

After the business hours of the store, the clerk can operate the operation unit 10 to perform a collection process. In the banknote handling apparatus 1, the proceeds from sales in the store on the day can be calculated. For example, there is a case where all the banknotes in the store should be deposited in the banknote handling apparatus 1 after the business hours. In this case, an amount obtained by subtracting the amount of banknotes having been stored in the banknote handling apparatus 1 before the business hours, from the total amount of banknotes being stored in the banknote handling apparatus 1 after the clerk has collected all the banknotes in the store and deposited the collected banknotes in the apparatus 1, is the proceeds from sales in the store on the day. The control unit 100 can calculate the amount of the proceeds from sales. When the amount of the proceeds from sales has been determined, the control unit 100 can determine the denominations and the number for each denomination of the banknotes constituting the proceeds from sales. The banknotes constituting the proceeds from sales are collection target banknotes. That is, the denominations and the number for each denomination of the collection target banknotes are determined so as to be equal to the amount of the proceeds from sales of that day. For example, the denominations and the number for each denomination of the collection target banknotes to be transported from the storage units 130 to the collection container 140 are determined based on: the amount of the proceeds from sales of that day; the total amount of the banknotes already stored in the collection container 140; and the number, for each denomination, of banknotes for change to be left in the storage units 130 and to be used for the next business day.

Based on the determination result, the control unit 100 can control the storage unit 130 to feed out, to the transport path, the collection target banknotes constituting the proceeds from sales (hereinafter simply referred to as “banknotes from sales”) out of the banknotes being stored in the storage unit 130. The banknotes from sales fed out from the storage unit 130 to the transport path are transported to the collection unit 140 and stored in the collection container 140. Specifically, while the banknotes for change necessary for the next business day are left in the storage unit 130, the remaining banknotes are collected as the banknotes from sales into the collection container 140. In the collection container 140, the banknotes from sales may be stored in a denomination mixed state.

If the collection container 140 becomes full of banknotes in the middle of the collection process, the control unit 100 can keep the remaining banknotes from sales in at least one of the storage units 130 as shown in FIG. 1C. Specifically, in the banknote handling apparatus 1, the banknotes for change necessary for the next business day are left in the storage units 130, while the banknotes from sales are stored dividedly in the collection container 140 and in at least one storage unit 130.

There are cases where banknotes from sales for a plurality of days are stored in the collection container 140 in a denomination mixed state. At least one storage unit 130 may store therein the banknotes from sales and the banknotes for change to be used for the business of the store. That is, the storage unit 130 may store therein the collection target banknotes and the banknotes for recycle use. The control unit 100 can store information on the storage states of these banknotes, in the inventory information and the collection information in the memory 110. The collection information includes information on that a part of the banknotes from sales is stored in at least one of the storage units 130.

The business hours on the next day will start with the banknotes constituting the proceeds from sales being dividedly stored in the collection container 140 and the storage unit 130 as shown in FIG. 1C. Even after the collection container 140 becomes full of banknotes, the clerk can continue to use the banknote handling apparatus 1. When dispensing banknotes from the storage unit 130 during the dispensing process, the control unit 100 can avoid dispensing banknotes equivalent to the amount of the banknotes from sales stored in this storage unit 130. The control unit 100 can perform the dispensing process by using banknotes equivalent to an amount calculated by excluding the amount of the banknotes from sales from the total amount of banknotes being stored in the storage unit 130. For example, if the total amount of banknotes being stored in the storage unit 130 is 500,000 yen and the amount of the banknotes from sales in this storage unit 130 is 100,000 yen, the dispensing process is performed by using banknotes of the remaining 400,000 yen.

According to kinds of banknotes deposited and dispensed during the business hours of the store, the control unit 100 can perform exchange between banknotes from sales and recycle banknotes that can be dispensed in the dispensing process. For example, if a large-denomination banknote, which can be exchanged for small-denomination banknotes from sales, is deposited, the control unit 100 can change the deposited large-denomination recycle banknote to a banknote from sales so that this large-denomination banknote can be stored and kept in the storage unit 130. On the other hand, the control unit 100 can change small-denomination banknotes from sales, whose amount is equivalent to the amount of the deposited large-denomination banknote regarded as the banknote from sales, to recycle banknotes so that these small-denomination banknotes can be used in the dispensing process.

For example, if one 200-euro banknote is stored in the storage unit 130 through the depositing process, the control unit 100 can exchange this 200-euro recycle banknote for twenty 10-euro banknotes having been stored as banknotes from sales in the storage unit 130. Specifically, the control unit 100 can regard the deposited one 200-euro banknote as a banknote from sales and keep it in the storage unit 130, and change, instead of this banknote, twenty 10-euro banknotes having been regarded as banknotes from sales, to recycle banknotes. Thus, the number of 10-euro banknotes that can be dispensed in the dispensing process is increased by 20.

Settings that allow the control unit 100 to specify a denomination of deposited banknotes that can be regarded as proceeds from sales and a denomination for which banknotes from sales can be changed to recycle banknotes, may be prepared in setting information in the memory 110 in advance.

Alternatively, the clerk can store, in the setting information in the memory 110, settings that allow the control unit 100 to automatically select a denomination for which a banknote from sales is changed to a recycle banknote. In this case, for example, based on transitional change in the number of banknotes for each denomination on the day, the control unit 100 can specify a denomination of recycle banknotes that are likely to run short on the day, and automatically selects the specified denomination as a denomination for which a banknote from sales is changed to a recycle banknote. If a banknote of a denomination exchangeable for banknotes of the automatically selected denomination is deposited, the control unit 100 can store the deposited banknote as a banknote from sales, and changes, instead of this banknote, the banknotes of the automatically selected denomination, from the banknotes from sales to the recycle banknotes.

As described above, based on the settings prepared in advance in the setting information in the memory 110, the control unit 100 can perform exchange between banknotes from sales, which cannot be dispensed in the dispensing process and are to be collected to outside the apparatus 1, and recycle banknotes, which can be dispensed in the dispensing process. After performing such banknote exchange, the control unit 100 updates related information such that the inventory information and the collection information stored in the memory 110 coincide with the banknote storage state of the storage units 130 after the exchange.

[Example 2 of Banknote Handling Process for Storing Collection Target Banknotes in Storage Unit]

In the example shown in FIG. 1C, both recycle banknotes and banknotes from sales are stored in one storage unit 130a. However, a certain storage unit 130 may be exclusively used for storing banknotes from sales so that banknotes from sales are not stored together with recycle banknotes in one storage unit 130.

For example, the clerk prepares, in the setting information in the memory 110, a setting such that a storage unit 130a is exclusively used only for collecting banknotes from sales if the collection container 140 becomes full of banknotes. When the collection process has started after the business hours of the store and the control unit 100 has recognized that at least a part of the banknotes from sales cannot be stored in the collection container 140, the control unit 100 can change the settings on the storage unit 130a from the setting for storing recycle banknotes for the assigned denomination to the setting for storing only banknotes from sales regardless of denominations.

The control unit 100 updates settings on the storage unit 130a, to the changed settings, in the setting information in the memory 110. After the update, the storage unit 130a is used as a banknote collection unit for storing only banknotes from sales.

Consequently, after the collection process has ended, a part of the banknotes from sales are stored in the collection container 140 while the remaining banknotes from sales, which could not be stored in the collection container 140, are stored in the storage unit 130a having been changed to be used as a collection unit. The collection container 140 and the storage unit 130a store only the banknotes from sales in a denomination mixed state, while the storage unit 130b does not store banknotes from sales and stores only the recycle banknotes. The number of storage units 130, whose purpose of use is changed from “storage unit” to “collection unit”, is not particularly limited. [Container Collection Process]

A determination condition for determining whether or not to request the CIT company for collection of proceeds from sales can be prepared in the setting information in the memory 110. The clerk can register the determination condition in the setting information by operating the operation unit 10. For example, the clerk may set the determination condition such that, if a part of banknotes from sales have been stored in a storage unit 130 after the business hours of the store, and the number of the banknotes from sales or the total number of recycle banknotes and the banknotes from sales stored in one storage unit 130 exceeds a predetermined number (threshold number), a request for collection of banknotes is made to the CIT company. The clerk can store this determination condition in the setting information. Alternatively, for example, the clerk may set the determination condition such that a request for collection of banknotes is made to the CIT company if the number of banknotes from sales or the total number of recycle banknotes and the banknotes from sales stored in one storage unit 130 exceeds a predetermined percentage of the maximum number of banknotes storable in this storage unit 130, and may store this determination condition in the setting information.

The clerk can set the determination condition, based on the number of banknotes from sales for which collection is requested to the CIT company, and on the maximum number of banknotes storable in the collection container 140, and may store this determination condition in the setting information. For example, the clerk may set the determination condition such that a request for collection of banknotes is made to the CIT company when the number of banknotes from sales (collection target banknotes) has reached a predetermined number corresponding to a predetermined number of times the capacity of the collection container 140 capable of storing a predetermined number of banknotes at maximum, and may store this determination condition in the setting information. For example, the determination condition is set such that it is satisfied when the number of collection target banknotes reaches 5,400 that is 1.8 times the capacity of the collection container 140 capable of storing 3,000 banknotes.

For example, after the collection process has been performed, the control unit 100 can determine whether or not the banknote storage state satisfies the determination condition set in advance. If the determination condition is satisfied, the control unit 100 can perform a notification process of requesting the CIT company for collection of banknotes. The notification process can be performed using the communication unit. In the notification process, a collection requesting notification, and information on the banknotes from sales to be collected by the CIT company can be transmitted to the communication terminal used by the CIT company. The information on the banknotes from sales can include: information on the denominations of the banknotes to be collected from the store, the number of banknotes for each denomination, and the total number and the total amount of the banknotes; and information on the number of collection containers 140 necessary for collecting the banknotes. For example, if two or more collection containers 140 are necessary for collecting the proceeds from sales of the store from the banknote handling apparatus 1, the number of the collection container 140 is notified in the notification process. The CIT company can confirm the notified information, and come to the store with the notified number of collection containers 140 for collecting the banknotes.

Upon receiving the request from the store, a person in charge of the CIT company (hereinafter simply referred to as “person in charge”) can head to the store with the notified number of collection containers 140. The person in charge having arrived at the store can operate the operation unit 10 of the banknote handling apparatus 1 to start the container collection process.

The container collection process will be described for the case where, after the business hours of the store, the person in charge visits the store with two collection containers 140b, 140c and performs the container collection process. After the business hours of the store, banknotes from sales of one day or a plurality of days are stored in the collection container 140a. For example, banknotes from sales on the first day and a part of banknotes from sales on the second day may be stored in the collection container 140a. Recycle banknotes and remaining banknotes from sales may be stored in at least one of the storage units 130 set to store banknotes for change for the assigned denomination.

When the person in charge has started the container collection process, information guiding the content of work to be performed by the person in charge can be displayed on the screen of the operation unit 10. After the container collection process has started, the number of banknotes from sales to be collected and/or instructions for the person in charge can be displayed on the screen of the operation unit 10.

The person in charge having checked the screen of the operation unit 10 dismounts, from the banknote handling apparatus 1, the collection container 140a storing the banknotes from sales, and mounts, to the collection unit 141, the empty collection container 140b he/she has brought to the store.

When the container collection process has started, the control unit 100 can recognize that there are the banknotes from sales being stored in at least one storage unit 130, based on the collection information in the memory 110. After the empty collection container 140b has been mounted to the collection unit 141, the control unit 100 can feed out the banknotes from sales from the at least one storage unit 130 and stores these banknotes in the collection container 140b. Information indicating that the banknote handling apparatus 1 is performing a process for storing banknotes in the second collection container 140b may be displayed on the operation unit 10.

After all the banknotes from sales have been fed out from the at least one storage unit 130 and stored in the collection container 140b, the control unit 100 can display information notifying this completion on the screen of the operation unit 10. Based on the notification, the person in charge can dismount, from the banknote handling apparatus 1, the second collection container 140b in which the banknotes from sales have been stored, and mount, to the collection unit 141, the empty collection container 140c he/she has brought to the store. When the collection container 140c is mounted to the collection unit 141, the control unit 100 can end the container collection process.

When the container collection process has ended, the collection container 140c mounted to the banknote handling apparatus 1 is empty, and only the recycle banknotes to be used for change are stored in the storage units 130. Meanwhile, the banknotes from sales for one or a plurality of business days are stored in the plurality of collection containers 140a, 140b and collected to outside the banknote handling apparatus 1.

The person in charge having finished the container collection process may carry the plurality of collection containers 140a, 140b, in which the proceeds from sales of the store are being stored, out from the store. The person in charge may carry the plurality of collection containers 140a, 140b from the store to a predetermined place. For example, the proceeds from sales are carried to a cash center where banknotes collected from a plurality of stores are handled.

[Confirmation of Banknote Information]

The control unit 100 can display, on the operation unit 10, information on the banknotes stored in the respective storage units 130 and/or information on the banknotes stored in the collection container 140, based on the inventory information and the collection information managed in the memory 110. The clerk and/or the person in charge of the CIT company can confirm, on the screen of the operation unit 10, the information on the banknotes stored in the banknote handling apparatus 1.

On an inventory confirmation screen, information on denominations, collection target banknotes and recycle banknotes can be displayed. As the information on denominations, denominations of banknotes stored in the banknote handling apparatus 1 can be displayed. The information on collection target banknotes can include: information on collection target banknotes in the storage unit 130; information on collection target banknotes in the collection container 140; and information on the total of collection target banknotes in these units 130, 140. As the information on recycle banknotes, the amount and/or the number of recyclable banknotes stored in the banknote handling apparatus 1 can be displayed. When a part of the banknotes stored in the storage unit 130 is regarded as proceeds from sales to be collected, the amount/number of banknotes other than the collection target banknotes (banknotes from sales) can be displayed as the information on recycle banknotes.

As the information on collection target banknotes, information on banknotes to be collected from the store can be displayed. As the information on collection target banknotes in the storage unit 130, the amount and/or the number of collection target banknotes stored in the storage unit 130 can be displayed. As the information on collection target banknotes in the collection container 140, the amount and/or the number of collection target banknotes stored in the collection container 140 can be displayed. As the information on the total of collection target banknotes in the storage unit 130 and the collection container 140, the total amount and/or the total number of the banknotes in these units 130, 140 can be displayed. In addition to the amount/number of recycle banknotes, the maximum amount/number of banknotes, which can be recycled in a predetermined condition, can be displayed. For example, the maximum amount/number of recyclable banknotes may be displayed in parentheses.

For example, when an emergency situation occurs while the control unit 100 performs the banknote handling process by using 5-euro recycle banknotes, the control unit 100 can perform the banknote handling process by using, as recycle banknotes, 5-euro banknotes from sales that have been stored as collection target banknotes in the storage unit 130. In this case, the maximum number of recycle banknotes that is a total of the recycle banknotes and the collection target banknotes is displayed on the screen of the operation unit 10. For example, after a notification for requesting delivery of 5-euro banknotes to the store was transmitted to the communication terminal of the CIT company, if the banknote handling apparatus 1 is not replenished with 5-euro banknotes after a predetermined time period has elapsed, the control unit 100 can determine that it is an emergency situation. The control unit 100 having determined the emergency situation can continue the banknote handling process by using, as recycle banknotes, other 5-euro banknotes that have been stored as collection target banknotes in the storage unit 130. For example, if there are 200 5-euro recycle banknotes and 100 5-euro collection target banknotes in the apparatus 1 in the emergency situation, 300 5-euro banknotes can be used as recycle banknotes to continue the banknote handling processes.

When the collection target banknotes have been used as recycle banknotes in the emergency situation, the control unit 100 can compensate for the amount of the used banknotes with banknotes of another denomination being stored in the banknote handling apparatus 1, or with banknotes newly stored in the banknote handling apparatus 1. For example, when four 5-euro banknotes having been stored as collection target banknotes are used as recycle banknotes in the dispensing process, the control unit 100 can change recycle banknotes of another denomination equivalent to the used 20 euros to collection target banknotes, and start to keep these collection target banknotes inside the apparatus 1. For example, the control unit 100 can change two 10-euro banknotes, one 20-euro banknote, or the like having been stored as recycle banknotes, to collection target banknotes, and keeps these banknotes in the storage unit 130 without recycling them.

Alternatively, for example, the control unit 100 can temporarily record the total amount, 20 euros, of the collection target banknotes used as recycle banknotes, and change banknotes of a denomination the number of which has been increased due to depositing and/or replenishment, to collection target banknotes. For example, when the CIT company has arrived at the store and replenished the banknote handling apparatus 1 with banknotes and thereby the number of 5-euro banknotes in the storage unit 130 has been increased, the control unit 100 can regard replenished four 5-euro banknotes as collection target banknotes and keeps them inside the apparatus 1. For another example, when a depositing process has been performed and one or a plurality of banknotes equivalent to 20 euros have been stored in the storage unit 130, the control unit 100 can regard the newly deposited banknotes equivalent to 20 euros as collection target banknotes and keeps these banknotes inside the apparatus 1.

When information on banknotes to be collected from the banknote handling apparatus 1 is to be confirmed, information on denominations, collection target banknotes and recycle banknotes can be displayed on the screen of the operation unit 10. As the information on denominations, denominations of banknotes to be collected from the banknote handling apparatus 1 can be displayed. The information on collection target banknotes can include: information on collection target banknotes in the storage unit 130; information on collection target banknotes in the collection container 140; and information on the total of collection target banknotes in these units 130, 140.

As the information on recycle banknotes, the amount and/or the number of banknotes to be left in the banknote handling apparatus 1 without being collected from the banknote handling apparatus 1 can be displayed. As the information on collection target banknotes, the amount and/or the number of collection target banknotes stored in the storage unit 130, the amount and/or the number of collection target banknotes stored in the collection container 140, and the total amount and/or the total number of these banknotes can be displayed.

On the screen, the number of collection containers 140 required for collecting the banknotes to outside the banknote handling apparatus 1 can also be displayed. For example, when the clerk needs to collect the banknotes from sales to outside the banknote handling apparatus 1 to hand over these collected banknotes to the CIT company, the clerk can check the screen of the operation unit 10 and prepare the notified number of collection containers 140 on the screen. The clerk can perform the container collection process by using these collection containers 140.

The information to be displayed on the screen for confirming banknote information can be changed by setting. For example, on the screen for confirming the inventory information of banknotes in the banknote handling apparatus 1, it can be set that information on collection target banknotes is not displayed. For example, on the screen for confirming the collection information on collection target banknotes, it can be set that information on recycle banknotes is not displayed.

Although the banknote handling apparatus 1 described above can perform a plurality of types of banknote handling processes, the banknote handling apparatus 1 may not necessarily perform all the aforementioned banknote handling processes, and may perform a part of the banknote handling processes described above.

The configuration of the banknote handling apparatus 1 shown in FIG. 1A is merely an example. The storage unit 130 is not limited to the stacking type storage unit in which banknotes are stacked and stored. The storage unit 130 may be a tape-type storage unit in which banknotes are stored while being wound around an outer circumferential surface of a drum together with tapes, and are fed out by reversely rotating the drum. The collection unit 141 may not necessarily store banknotes in a collection bag serving as the collection container 140. The collection unit 141 may store banknotes in a cassette detachably mounted to the collection unit 141. The operation unit 10 may not necessarily serve both as an operation unit and a display unit. An operation unit and a display unit may be independent units. The operation unit 10 may not necessarily be included in the banknote handling apparatus 1. A mobile terminal communicably connected to the banknote handling apparatus 1 wirelessly or via a wire may be used as the operation unit 10.

How many consecutive days over which the banknote handing apparatus 1 can be continuously used while storing therein banknotes from sales for these days, depends on the number of banknotes storable in each storage unit 130, the number of banknotes storable in the collection container 140, the number of banknotes necessary for change (change fund), the number of banknotes from sales, etc. Although banknotes are collected in a plurality of collection containers 140 (collection bags) when being collected to outside the banknote handling apparatus 1, this is also an example, and banknotes may be collected in three or more collection containers 140 depending on the number of banknotes to be collected. By repeating the process of dismounting a collection container 140 in which collection target banknotes are being stored, and mounting an empty collection container 140 to the collection unit 141 to store collection target banknotes left in the storage unit 130, the container collection process can be performed regardless of the number of the collection containers 140.

In the banknote handling apparatus 1, even when the number of collection target banknotes in the apparatus 1 exceeds the maximum number of banknotes storable in the collection container 140, a part of the collection target banknotes can be stored in at least one storage unit 130 having been used for storage of recycle banknotes only, whereby the banknote handling process including the depositing process and the dispensing process can be continuously performed. The banknote handling apparatus 1 can perform the notification process of notifying the clerk of the store and/or the person in charge of the CIT company that collection of banknotes is necessary, before it becomes a state where the banknote handling process can no longer be continued. In the notification process, the number of collection containers 140 necessary for collecting banknotes can be notified. In the banknote handling apparatus 1, when the container collection process is started to store banknotes in the collection container 140 to collect these banknotes to outside the apparatus 1, information indicating the banknote collecting state can be displayed on the screen of the operation unit 10. A person in charge of the collection work can prepare the necessary number of collection containers 140 in advance, and can smoothly progress the collection work while checking the screen of the operation unit 10.

[Specific Example of the Banknote Handling Apparatus]

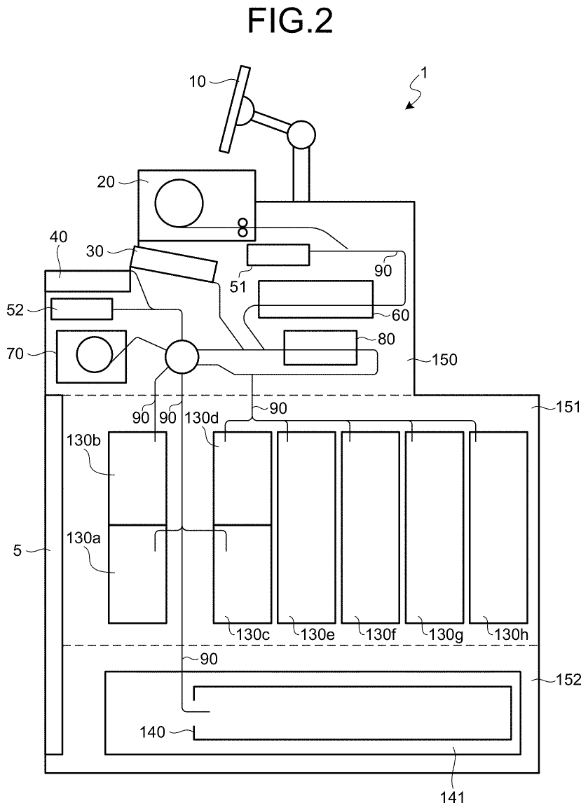

Next, a specific example of the banknote handling apparatus 1 will be described. FIG. 2 is a cross-sectional view schematically showing an internal configuration of the banknote handling apparatus 1. FIG. 3 is a block diagram schematically showing a functional configuration of the banknote handling apparatus 1. For example, the banknote handling apparatus 1 is installed in a back office of a store. The banknote handling apparatus 1 can perform various banknote handling processes including a depositing process and a dispensing process. For example, the banknote handling apparatus 1 can perform a process of dispensing banknotes to be used as change at a checkout counter of the store, and a process of depositing banknotes collected, as proceeds from sales of the store, from the checkout counter.

As shown by a broken line in FIG. 2, the banknote handling apparatus 1 is divided into three units, i.e., a banknote handling unit 150, a first safe unit 151, and a second safe unit 152. Storage units 130 (130a to 130h) disposed in the first safe unit 151 and a collection container 140 of a collection unit 141 disposed in the second safe unit 152 can store banknotes processed in the banknote handling unit 150. The first safe unit 151 and the second safe unit 152 are metallic safes. The banknotes stored in the storage units 130 and the collection container 140 cannot be taken out from the apparatus unless a locked metallic safe door 5 is unlocked with a predetermined key and opened. Since the storage units 130 and the collection unit 141 in which a large quantity of banknotes are stored are respectively disposed in the first safe unit 151 and the second safe unit 152, security of the banknotes is ensured.

The banknote handling unit 150 includes a cassette 20, a depositing unit 30, a dispensing unit 40, a first reject unit 51, a second reject unit 52, a rotary unit 60, a temporary storage unit 70, and a recognition unit 80.

The recognition unit 80 includes various types of sensors such as an image sensor, an ultrasonic sensor, and a magnetic sensor. Using the sensors, the recognition unit 80 acquires recognition data for recognizing the kind of each banknote. The recognition data includes, for example, data for recognizing the denomination, authenticity, and fitness of each banknote. The recognition unit 80 transmits the acquired recognition data to the control unit 100 (see FIG. 3). For example, the recognition unit 80 transmits data of a banknote image acquired by the image sensor to the control unit 100. The banknote image enables the control unit 100 to specify the kind of the banknote and read a serial number of the banknote.

The transport unit 90 includes: a transport mechanism (conveyer) having rollers and belts for transporting banknotes along a transport path; and a diversion mechanism for changing the banknote transporting direction at diverting points disposed on the transport path. The transport mechanism and the diversion mechanism are controlled by the control unit 100 to transport banknotes along the transport path connecting each unit in the apparatus 1. The transport path in the banknote handling unit 150 is connected to a transport path disposed in the first safe unit 151 and a transport path disposed in the second safe unit 152. Each of the first safe unit 151 and the second safe unit 152 has a slit-like opening at an upper surface thereof. Banknotes are transported into each safe unit 151, 152 from the outside along the transport path that passes through this opening. Thus, the transport unit 90 can transport the banknotes processed in the banknote handling unit 150 to the storage units 130 in the first safe unit 151 and to the collection container 140 in the second safe unit 152.

Each of the storage units 130 disposed in the first safe unit 151 includes a stacking mechanism for stacking banknotes. The stacking mechanism is controlled by the control unit 100 to stack the banknotes having been transported along the transport path, such that the faces thereof are substantially horizontal. Each storage unit 130 further includes a feeding mechanism composed of a plurality of rollers for feeding out banknotes to the transport path connected to the storage unit 130. The feeding mechanism is controlled by the control unit 100 to feed out the banknotes stacked in the storage unit 130, in order from an uppermost banknote, to the transport path connected to the storage unit 130.

The operation unit 10 is disposed on an upper portion of the banknote handling unit 150. The operation unit 10 is, for example, a touch panel type liquid crystal display device, and functions as a display unit as well as an operation unit. A clerk performs, with the operation unit 10, operations such as: confirmation of information on banknotes stored in the banknote handling apparatus 1; confirmation and update of a setting on a banknote handling process; and instruction related to the banknote handling process. The information inputted through the operation unit 10 is transmitted to the control unit 100.

The clerk, by operating the operation unit 10, can set, for each storage unit 130, information indicating the kind of banknotes to be stored in the storage unit 130. The control unit 100 associates the information indicating the kind of banknotes, which is inputted by using the operation unit 10 by the clerk, with information indicating the storage unit 130. The control unit 100 stores, in the memory 110, information indicating the relationship between the kind of banknotes and the storage unit 130. The control unit 100 controls the depositing unit 30, the temporary storage unit 70, the recognition unit 80, the transport unit 90, and the storage unit 130, based on the information stored in the memory 110, thereby storing banknotes in the corresponding one among the plurality of storage units 130.

The kinds of banknotes to be recognized by the banknote handling apparatus 1 includes denomination. The kinds of banknotes may include at least one of fitness and authenticity, in addition to denomination. The kinds of banknote may further include information indicating a currency such as Canadian dollar, US dollar, Mexican peso, or Euro.

The clerk, by operating the operation unit 10, can set, for a certain storage unit 130, information indicating that banknotes are not to be stored therein. The control unit 100 stores, in the memory 110, the information on the setting of the storage unit 130. For example, when an inventory confirmation process of checking banknotes in one storage unit 130 is performed, an empty storage unit 130 set not to store banknotes is used as a temporary storage place for the fed-out banknotes, which are fed out, one by one, from the one storage unit 130. The confirmation process will be described later in detail.

Operations to be performed on the operation unit 10 include: a depositing operation of inputting information necessary for the depositing process of transporting deposited banknotes from the depositing unit 30 or the cassette 20 to the storage unit 130; a dispensing operation of inputting information necessary for the dispensing process of transporting banknotes to be dispensed, from the storage unit 130 to the dispensing unit 40 or the cassette 20; a collection operation of inputting information necessary for the collection process of transporting banknotes to be collected into the collection container 140, from the storage unit 130 to the collection unit 141; and a container collection operation of inputting information necessary for the container collection process of dismounting the collection container 140 in which banknotes to be collected are being stored, from the banknote handling apparatus 1.

Each storage unit 130 is detachably mounted to the banknote handling apparatus 1. Specifically, the storage unit 130 is detachably disposed on a frame that is movable in the front-rear direction (the left-right direction in FIG. 2) of the banknote handling apparatus 1. The safe door 5 disposed at the front face of the banknote handling apparatus 1 is opened, and the frame is drawn out from the safe unit 151 toward the front face side of the apparatus 1, whereby the storage unit 130 can be mounted/dismounted with respect to the frame. Although FIG. 2 shows a case where a total of eight storage units 130 of two types, i.e., four small storage units 130a to 130d and four large storage unit 130e to 130h, are disposed, the types and the number of storage units 130 are not particularly limited.

The collection unit 141 disposed in the second safe unit 152 includes: a stacking mechanism for stacking, in the collection container 140, banknotes having been transported by the transport unit 90; and a storage mechanism including a lever for pushing the banknotes stacked by the stacking mechanism into the collection container, and a driving unit for driving the lever. The collection unit 141 is disposed on a frame that is movable in the front-rear direction (the left-right direction in FIG. 2) of the banknote handling apparatus 1.

The collection container 140 is detachably mounted to the banknote handling apparatus 1. The safe door 5 disposed at the front face of the banknote handling apparatus 1 is opened, and the frame on which the collection unit 141 is disposed is drawn out from the second safe unit 152 toward the front face side of the apparatus 1, whereby the collection container 140 can be set and removed with respect to the collection unit 141.

The collection container 140 is a bag for storing collection target banknotes. However, the collection container 140 is not limited to the bag, and may be a cassette including a container, a lid that is opened and closed by the clerk when banknotes in the container are taken out, and a lock mechanism that locks the lid in the closed state. When the collection container 140 is such a cassette, for example, a storage mechanism that includes a plurality of rollers and a stage for supporting banknotes and that stores banknotes having been transported by the transport unit 90 into the container, is disposed on the cassette side.

As shown in FIG. 3, the banknote handling apparatus 1 includes a control unit 100, a memory 110, and a communication unit 120 in addition to the components shown in FIG. 2. The control unit 100 may be called a controller, a circuit, a processor, or a computer device. The communication unit 120 is controlled by the control unit 100 to exchange information with an external device. The communication unit 120 is communicably connected to the external device via a network such as a LAN, a WAN, or the Internet. For example, if the collection container 140 in which banknotes are stored needs to be dismounted from the banknote handling apparatus 1 and carried outside the store, the control unit 100 controls the communication unit 120 to transmit information for requesting the collection of the collection container 140 to the communication terminal (external device) installed in the CIT company. The external device communicating with the communication unit 120 may be a communication terminal installed inside the store. In this case, the control unit 100 may transmit the information for requesting the collection of the collection container 140 to the communication terminal installed in the CIT company via the communication terminal in the store. The communication terminal may be called a computer device.

The memory 110 is a non-volatile memory device. The memory 110 stores inventory information 111, collection information 112, and setting information 113. The inventory information 111 includes: information indicating the denominations of banknotes stored in the respective storage units 130, and the number and the amount of the banknotes for each denomination; and information indicating the denominations of banknotes stored in the collection container 140, and the number and the amount of the banknotes for each denomination. The collection information 112 includes: information indicating the denominations of collection target banknotes, and the number and the amount of the banknotes for each denomination; and information indicating a place where the collection target banknotes are stored. The inventory information 111 and the collection information 112 include information on serial number of each banknote. The setting information 113 includes: information indicating the kinds of banknotes to be stored in the respective storage units 130; and information indicating the contents of banknote handling processes to be performed in the banknote handling apparatus 1. The clerk can display the various kinds of information including the inventory information 111, the collection information 112, and the setting information 113 on the screen of the operation unit 10 by operating the operation unit 10. Moreover, the clerk can update the setting information 113 stored in the memory 110 by operating the operation unit 10.

The control unit 100 controls the components shown in FIGS. 2 and 3 while using the various kinds of information stored in the memory 110, based on operations performed on the operation unit 10. The control unit 100 recognizes the kind of each banknote, based on the recognition data acquired by the recognition unit 80. For example, the denomination, authenticity, and fitness of the banknote are recognized. Moreover, the control unit 100 counts the number of banknotes for each kind, based on the recognition data acquired by the recognition unit 80. For example, the number of banknotes for each denomination is counted. Then, information of each banknote and information indicating the number of banknotes for each kind are transmitted from the control unit 100 to the memory 110, and stored in the memory 110 as the inventory information 111.

The control unit 100 controls the respective components based on the information inputted through the operation unit 10 and the communication unit 120 such that the functions and operations of the banknote handling apparatus 1 described in the present embodiment are implemented. The banknote handling apparatus 1 can perform various banknote handling processes.

[Depositing Process]

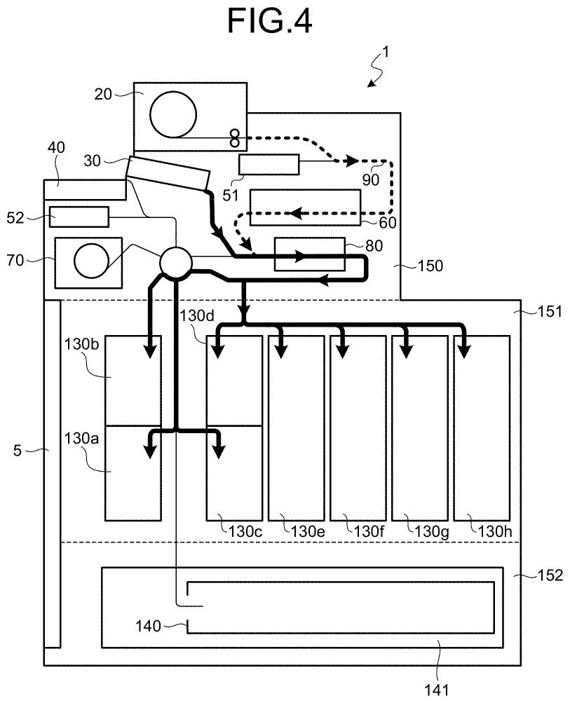

FIG. 4 is a schematic diagram illustrating a depositing process performed in the banknote handling apparatus 1. In FIG. 4 and the subsequent figures, the operation unit 10 is omitted from figures. The clerk operates the operation unit 10 to start the depositing process. The depositing process is a process of receiving banknotes from outside the apparatus 1, and storing the received banknotes inside the apparatus 1. The clerk can deposit banknotes in the apparatus from the depositing unit 30. The clerk can also deposit banknotes in the apparatus from the cassette 20 detachably mounted to the banknote handling apparatus 1.

When performing the depositing process by using the depositing unit 30, the clerk can place a plurality of banknotes on the depositing unit 30. The depositing unit 30 is controlled by the control unit 100 to feed out the placed banknotes one by one to the transport path inside the apparatus 1. The transport unit 90 is controlled by the control unit 100 to transport the banknotes along the transport path as indicated by solid-line arrows in FIG. 4. The banknotes fed out from the depositing unit 30 are transported to the recognition unit 80. The control unit 100 acquires by using the recognition unit 80 an image of each banknote, and reads a serial number of the banknote from the image. Based on recognition data acquired in the recognition unit 80, the control unit 100 recognizes the kind of the banknote and determines whether or not the banknote can be deposited. When the control unit 100 has determined that the banknote can be deposited, the banknote is, based on the recognition result, transported to one of the plurality of storage units 130a to 130h that corresponds to the kink of the banknote. The storage unit 130 stores the transported banknote.

A reject note that is determined by the control unit 100 not to be depositable is transported to the dispensing unit 40. The transported reject note is stacked in the dispensing unit 40. The dispensing unit 40 is configured such that rejected banknotes stacked therein can be taken out from the apparatus 1. Rejected banknotes stacked in the dispensing unit 40 are removed from the dispensing unit 40 by the clerk.

In an exemplary implementation, the depositing unit 30 is a depository, repository, dispensary or other type of receptacle that receives banknotes during the depositing process. The dispensing unit 40 stacks banknotes to be dispensed during the dispensing process. In some implementations, a container is one or both the depositing unit 30 and the dispensing unit 40, performing one or both of the depositing process and the dispensing process.

When setting information indicating that counterfeit notes should be kept in the banknote handling apparatus 1 is stored in the memory 120, a reject note recognized as a counterfeit note by the control unit 100 is transported not to the dispensing unit 40 but to the second reject unit 52. The second reject unit 52 stores and keeps the transported reject note. Alternatively, a counterfeit note, after having been temporarily stored in the temporary storage unit 70, is fed out from the temporary storage unit 70 to the transport path at a predetermined timing, is transported to the first reject unit 51, and is stored and kept in the first reject unit 51.

The depositing process for banknotes in the depositing unit 30 can be performed by using the temporary storage unit 70. In this case, banknotes having passed through the recognition unit 80 are transported along the transport path inside the banknote handling unit 150, and are stored in the temporary storage unit 70. When all the banknotes to be deposited have been stored in the temporary storage unit 70, the counting result of these banknotes is displayed on the operation unit 10. Then, the clerk performs an operation to accept the counting result, whereby each of the banknotes stored in the temporary storage unit 70 is fed out and transported to the storage unit 130 corresponding to the recognition result of each banknote. The storage unit 130 stores the transported banknotes. If the clerk performs an operation to cancel the depositing process instead of the acceptance, the banknotes fed out from the temporary storage unit 70 are transported to the dispensing unit 40. The dispensing unit 40 stacks the transported banknotes. The banknotes stacked in the dispensing unit 40 are removed from the dispensing unit 40 by the clerk and returned to the clerk.

The depositing process can also be performed by using the cassette 20. In this case, the clerk may use another banknote handling apparatus in order to previously store, in the cassette 20, banknotes to be deposited in the banknote handling apparatus 1. The cassette 20 can be detachably mounted to another banknote handling apparatus 1. For example, the cassette 20 can be detachably mounted to a change machine that stores money received from a customer when a transaction with the customer is performed at the checkout counter of the store, and that dispenses change according to need. For example, in order to collect banknotes from the change machine and deposit the collected banknotes in the banknote handling apparatus 1, the clerk performs a process of mounting the cassette 20 to the change machine, and storing collection target banknotes into the cassette 20 inside the change machine. The clerk dismounts, from the change machine, the cassette 20 in which the collection target banknotes have been stored, mounts the cassette 20 to the banknote handling apparatus 1 as shown in FIG. 4, and performs the depositing operation by using the operation unit 10. When the depositing process has started in the banknote handling apparatus 1, the cassette 20 under control of the control unit 100 feeds out the banknotes in the cassette 20, one by one, to the transport path in the apparatus 1.

The transport unit 90 transports the banknotes to the rotary unit 60 as indicated by broken-line arrows in FIG. 4. The rotary unit 60 rotates the banknotes such that the top/bottom orientation of the banknotes is changed without changing the face/back orientation of the banknotes. The rotary unit 60 includes a plurality of rollers for rotating the banknotes. The control unit 100 controls the rotation speed of each roller of the rotary unit 60. For example, the plurality of rollers disposed in the direction orthogonal to the banknote transport direction are in contact with a face of each banknote, and the rollers rotate at different rotation speeds, whereby the banknote is rotated.

The banknotes in the cassette 20 are fed out such that the long edges of each banknote are parallel to the transport direction. On the other hand, the banknotes in the depositing unit 30 are fed out such that the short edges of each banknote are parallel to the transport direction, are transported along the transport path, and are stored in the storage unit 130. The rotary unit 60 rotates the banknotes fed out from the cassette 20 by 90 degrees such that the short edges of each banknote become parallel to the transport direction, whereby the rotated banknotes can be processed in the same as the banknotes deposited from the depositing unit 30.

The banknotes rotated in the rotary unit 60 are transported to the recognition unit 80, and are processed similarly to the case of depositing banknotes from the depositing unit 30. Furthermore, similarly to the case of depositing banknotes from the depositing unit 30, the banknotes in the cassette 20 can be deposited by using the temporary storage unit 70. In this case, the banknotes fed out from the cassette 20 are transported along the transport path in the banknote handling unit 150, and are stored temporarily in the temporary storage unit 70. After the clerk has performed, with the operation unit 10, an operation to accept the counting result of the banknotes, the banknotes are fed out from the temporary storage unit 70 and stored in the storage unit 130. If the clerk has performed an operation to cancel the depositing process, the banknotes fed out from the temporary storage unit 70 are returned to and stored in the cassette 20.

[Dispensing Process]

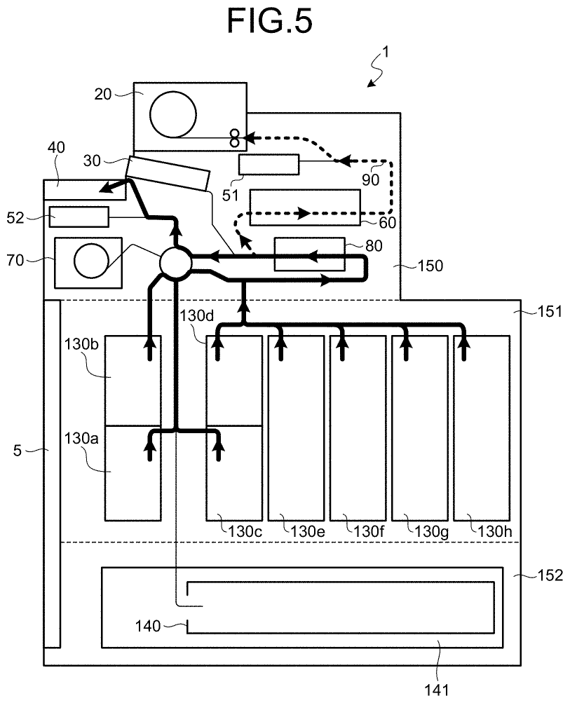

The clerk can perform a dispensing process by operating the operation unit 10. FIG. 5 is a schematic diagram illustrating a dispensing process performed in the banknote handling apparatus 1. The dispensing process is a process of feeding out banknotes from the storage unit 130, and discharging these banknotes from the apparatus 1. For example, the clerk performs, with the operation unit 10, a dispensing operation for dispensing banknotes stored in the storage unit 130 to the cassette 20. In this case, the control unit 100 receives, from the operation unit 10, information indicating the content of dispensing inputted by the clerk, and controls the transport unit 90, the storage unit 130, and the cassette 20 to perform the dispensing process. Alternatively, for example, the clerk may perform, with the operation unit 10, a dispensing operation of dispensing banknotes from the storage unit 130 to the dispensing unit 40. In this case, the control unit 100 receives, from the operation unit 10, information indicating the content of dispensing inputted by the clerk, and controls the transport unit 90, the storage units 130, and the dispensing unit 40 to perform the dispensing process.

When performing the dispensing process by using the dispensing unit 40, the clerk designates the content of dispensing by operating the operation unit 10, whereby the storage unit 130 under control of the control unit 100 feeds out banknotes to be dispensed, one by one, to the transport path. The transport unit 90 under control of the control unit 100 transports the banknotes as indicated by solid-line arrows in FIG. 5. The banknotes fed out from the storage unit 130 are transported to the recognition unit 80. Based on recognition data acquired in the recognition unit 80, the control unit 100 determines whether or not each banknote can be dispensed. When the control unit 100 has determined that the banknote can be dispensed, the banknote is transported to the dispensing unit 40. The transported banknotes are stacked in the dispensing unit 40. The clerk can take out the dispensed banknotes from the dispensing unit 40. When determining whether or not each banknote can be dispensed, the control unit 100 may recognize a serial number of the banknote, based on the recognition data acquired in the recognition unit 80.

A reject note that is determined by the control unit 100 not to be dispensable is transported to the first reject unit 51. For example, the reject note, after having been temporarily stored in the temporary storage unit 70, is fed out from the temporary storage unit 70 to the transport path at a predetermined timing, is transported to the first reject unit 51, and is stored and kept in the first reject unit 51. Alternatively, the reject note may be transported to the second reject unit 52, and stored and kept in the second reject unit 52.

There is a case where reject note recognized as a counterfeit note by the control unit 100 in the depositing process, and a reject note determined by the control unit 100 not to be dispensable in the dispensing process are to be handled in different manners after having been taken out from the apparatus 1. In this case, a setting may be previously prepared in the memory 110, such that the counterfeit note in the depositing process and the reject note in the dispensing process are stored separately in the first reject unit 51 and the second reject unit 52. For example, when the setting indicating that a banknote determined as a counterfeit note in the depositing process should be stored in the second reject unit 52 while a banknote determined as a reject note in the dispensing process should be stored in the first reject unit 51, is prepared in the memory 110, the control unit 100 controls the respective units based on this setting. Consequently, the reject note in the depositing process is stored in the first reject unit 51 while the reject note in the dispensing process is stored in the second reject unit 52.

When performing the dispensing process by using the cassette 20, the clerk designates the content of dispensing by operating the operation unit 10, whereby the storage unit 130 under control of the control unit 100 feeds out banknotes to be dispensed, one by one, to the transport path. The transport unit 90 under control of the control unit 100 transports the fed-out banknote to the recognition unit 80, and thereafter, diverges this banknote by a diversion mechanism on the transport path. The transport unit 90 transports the banknote diverged by the diversion mechanism to the cassette 20 as indicated by broken-line arrows in FIG. 5. In the middle of the transport, the rotary unit 60 under control of the control unit 100 rotates the banknote by 90 degrees in parallel to the note faces, with the face/back orientation being unchanged, so that the long edges of the banknote, which has been transported with the short edges being parallel to the transport direction, become parallel to the transport direction. The rotary unit 60 is provided with a line sensor (not shown), and this line sensor detects the orientation of the rotated banknote. Information on the orientation of the banknote detected by the line sensor is transmitted to the control unit 100. Based on the received information on the orientation of the banknote, the control unit 100 determines whether or not the banknote can be dispensed, i.e., whether or not the banknote can be stored in the cassette 20. The control unit 100 controls the transport unit 90 such that a banknote determined to be dispensable is transported to the cassette 20 while a banknote determined not to be dispensable is transported to the first reject unit 51. The cassette 20 stores the transported banknote. The first reject unit 51 stores the transported reject note.

[Inventory Confirmation Process]

An inventory confirmation process is a process of confirming that the number of banknotes actually stored in the storage unit 130 is equal to the number of banknotes managed in the inventory information 111 and the collection information 112 stored in the memory 110.

While banknotes are stored in and fed out from the storage unit 130, abnormal transport, such as overlapping in which a plurality of banknotes are transported in an overlapping state, may occur. The abnormal transport causes a situation where the number of banknotes actually stored in the storage unit 130 cannot be determined. In this case, the control unit 100 performs the inventory confirmation process to check the banknotes being stored in the storage unit 130.

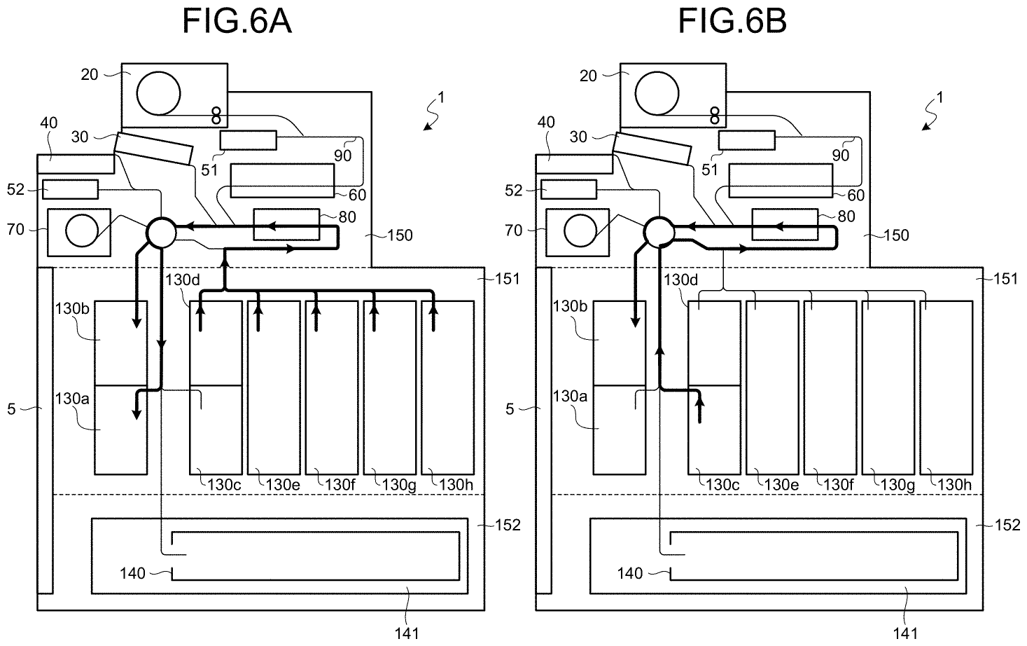

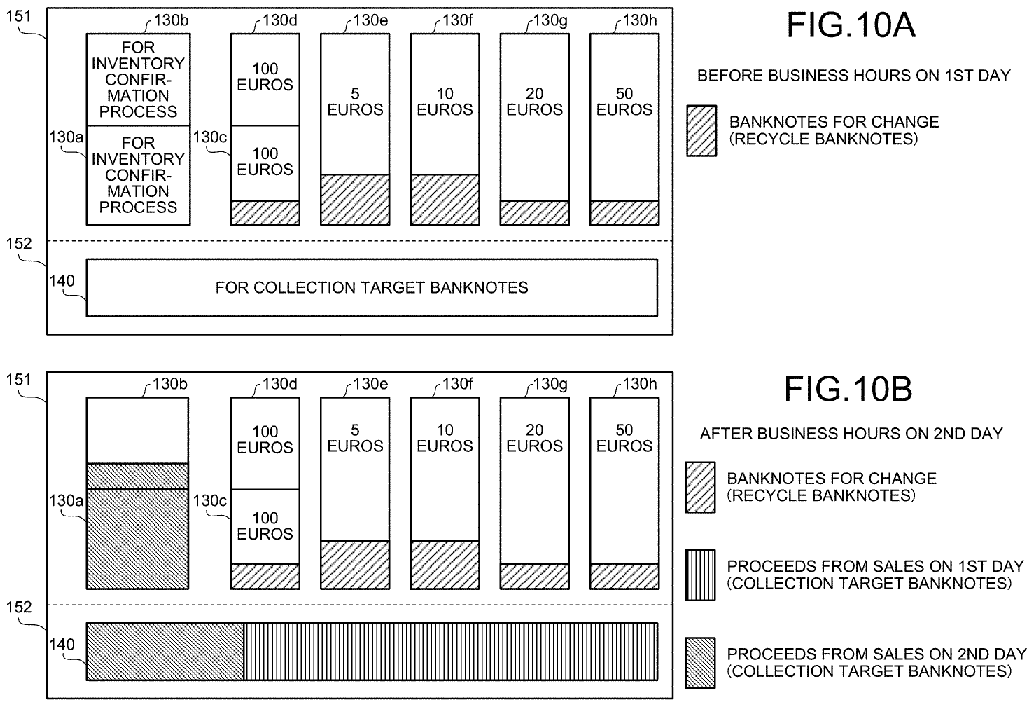

FIGS. 6A and 6B are schematic diagrams illustrating the inventory confirmation process performed in the banknote handling apparatus 1. The inventory confirmation process using empty storage units 130a, 130b being ensured for inventory confirmation (see FIG. 10A) will be described.

When checking banknotes in the storage units 130d to 130h, the control unit 100 feeds out the banknotes one by one from each of the storage units 130d to 130h, transports the banknotes as indicated by arrows in FIG. 6A, acquires recognition data in the recognition unit 80, and stores the banknotes in the storage unit 130a. When the storage unit 130a has become full of banknotes, the control unit 100 stores subsequent banknotes in the storage unit 130b. Even when a large number of banknotes are stored in the large-size storage units 130e to 130h, all the banknotes can be checked and stored in the two storage units 130a, 130b. Although FIG. 6A shows the transport paths for banknotes in the respective storage units 130d to 130h, the inventory confirmation process is performed to one storage unit 130 as a target. Even when a plurality of storage units 130 are to be checked, the storage units 130 are checked one by one.

Meanwhile, when checking banknotes in the storage unit 130c, the control unit 100 feeds out the banknotes one by one from the storage unit 130c, transports the banknotes as shown by arrows in FIG. 6B, acquires recognition data in the recognition unit 80, and stores the banknotes in the storage unit 130b.

After the recognition data of all the banknotes stored in one storage unit 130 has been acquired, the control unit 100 feeds out the banknotes stored in the storage units 130a, 130b, and transports the banknotes to the original storage unit 130 in which the banknote have been stored before starting the inventory confirmation process. For example, the banknotes fed out from the storage units 130a, 130b are transported to the original storage unit 130 by reversely tracking the route along which the banknotes were transported to the storage units 130a, 130b.

Based on the recognition data acquired in the recognition unit 80, the control unit 100 performs, for all the banknotes stored in one storage unit 130, recognition of each banknote, reading of a serial number from each banknote, and counting of the banknotes. Thus, the control unit 100 can confirm the inventory of the storage unit 130, that is, the denominations of banknotes actually stored in the storage unit 130, the number of banknotes for each denomination, and the total amount of the banknotes.

As described above, the banknote handling apparatus 1 feeds out and checks all banknotes being stored in each storage unit 130 one by one, thereby confirming that the banknotes actually stored in the storage units 130 coincide with the banknote information managed in the inventory information 111 and the collection information 112.

[Collection Process]

The clerk can perform the collection process by operating the operation unit 10. In the collection process, banknotes equivalent to the amount of proceeds from sales of the store on the day are regarded as collection target banknotes. The collection process includes a process of storing collection target banknotes fed out from the storage unit 130 into the collection container 140, and storing, in the memory 10, information on the amount of the collection target banknotes stored in the collection container 140 as information on the proceeds from sales.

In the banknote handling apparatus 1, even when the number of collection target banknotes exceeds the maximum number of banknotes storable in the collection container 140, the collection target banknotes can be stored inside the apparatus 1. The collection process includes a process in which, if the collection container 140 becomes full of banknotes in the middle of the collection process, the amount of collection target banknotes that cannot be transported from one or more storage units 130 to the collection container 140 is recorded as the proceeds from sales while these collection target banknotes are left in the storage units 130. In this case, the amount of the collection target banknotes stored in the collection container 140, the amount of the collection target banknotes left in the storage units 130 and regarded as the proceeds from sales, and information indicating the storage units 130 in which the collection target banknotes are left, are stored in the memory 110 as information on the proceeds from sales.

The collection process includes a process in which, if the collection container 140 is already full of banknotes before starting the collection process, the amount of collection target banknotes that are being stored in one or more storage units 130 is recorded as the proceeds from sales. In this case, the amount of the collection target banknotes regarded as the proceeds from sales, and information indicating the storage units 130 in which the collection target banknotes are being stored, are stored in the memory 110 as information on the proceeds from sales.

In the banknote handling apparatus 1, the information on the proceeds from sales is stored in the collection information 112 in the memory 110. Specifically, information indicating the storage places of the collection target banknotes, i.e., the banknotes equivalent to the amount recorded as the proceeds from sales, and information indicating the denominations of collection target banknotes stored in each storage place, the number of the banknotes for each denomination, and the total amount of the banknotes, are stored as the information on the proceeds from sales. The “storage place” is information indicating the place where the collection target banknotes, i.e., the banknotes whose information is registered in the collection information 112 in the memory 110, are stored. In the banknote handling apparatus 1, even after the collection container 140 has become full of the collection target banknotes, additional collection target banknotes can be stored and kept in the storage units 130. Therefore, the “storage place” may include only the collection container 140, or the collection container 140 and one or more storage units 130.

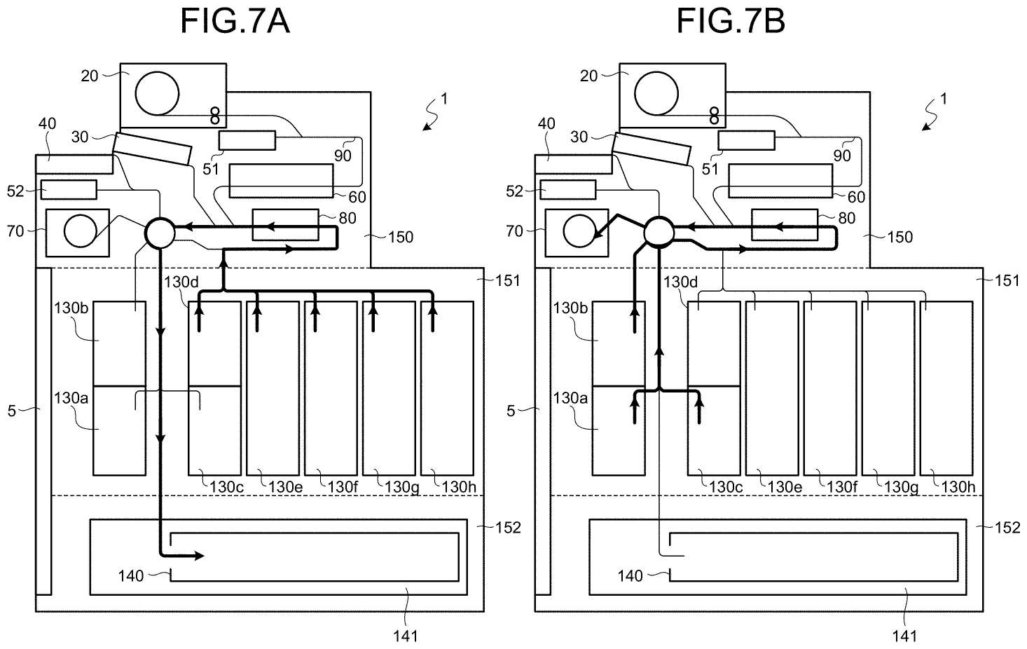

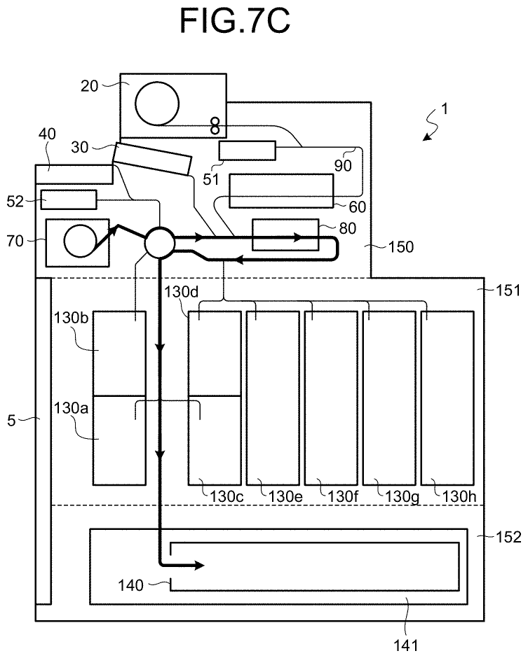

The clerk operates the operation unit 10 to input the content of the collection process, whereby the control unit 100 starts the collection process. When the collection process has started, the collection target banknotes are fed out from the storage unit 130 and stored in the collection container 140. FIGS. 7A to 7C are schematic diagrams showing movement of banknotes during the collection process performed in the banknote handling apparatus 1. FIG. 7A shows movement of banknotes to be collected from the storage units 130d to 130h, and FIGS. 7B and 7C show movement of banknotes to be collected from the remaining storage units 130a to 130c. Although FIG. 7A and FIG. 7B each show movement of banknotes from a plurality of storage units 130, when the banknotes are collected, the banknotes are sequentially fed out from each storage unit 130 to the transport path, are transported by the transport unit 90 to the collection unit 141, and are stored in the collection container 140 in the collection unit 141.

When banknotes are to be collected from the storage units 130d to 130h, the banknotes in each of the storage units 130d to 130h are fed out one by one to the transport path, are recognized and counted by the control unit 100 based on the recognition data acquired in the recognition unit 80, and are stored in the collection container 140 as shown in FIG. 7A.

When banknotes are collected from the storage units 130a to 130c, the banknotes in each of the storage units 130a to 130c are fed out one by one, are recognized and counted by the control unit 100 based on the recognition data acquired in the recognition unit 80, and are temporarily stored in the temporary storage unit 70 as shown in FIG. 7B. Thereafter, the banknotes are fed out from the temporary storage unit 70 to the transport path at a predetermined timing, and are stored in the collection container 140 as shown in FIG. 7C.

The counting result obtained by the control unit 100 is transmitted to the memory 110 and stored in the collection information 112. After the collection container 140 has become full of banknotes, the control unit 100 uses the storage units 130 for storing collection target banknotes. Hereinafter, three specific examples of the banknote handling process in which the storage units 130 are used for storage of collection target banknotes will be described.

[Example 1 of Banknote Handling Process of Storing Collection Target Banknotes in Storage Unit]

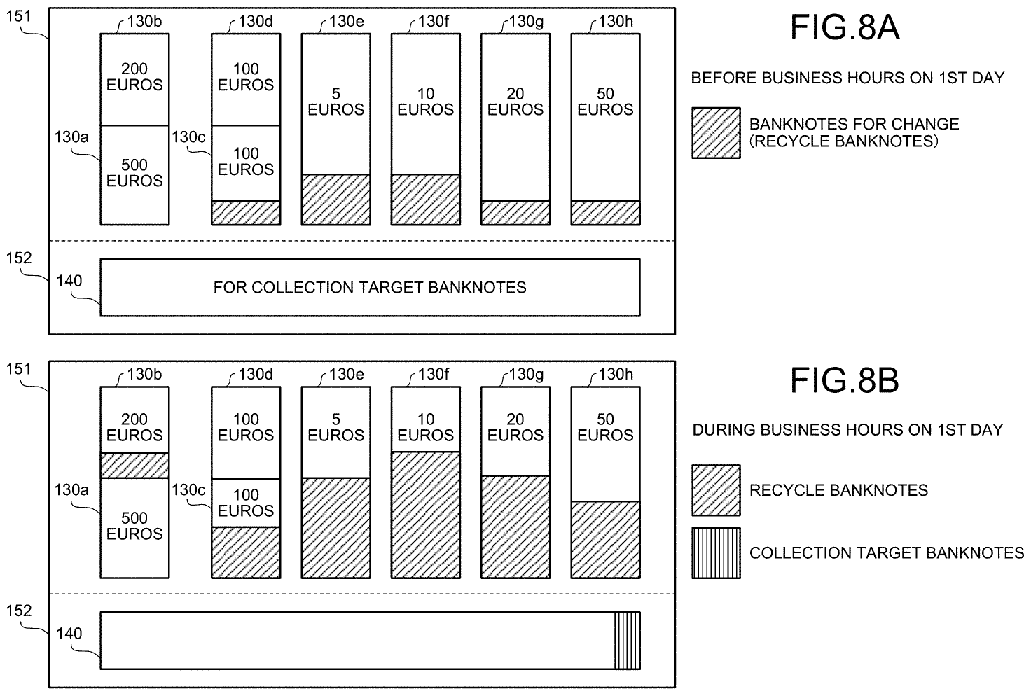

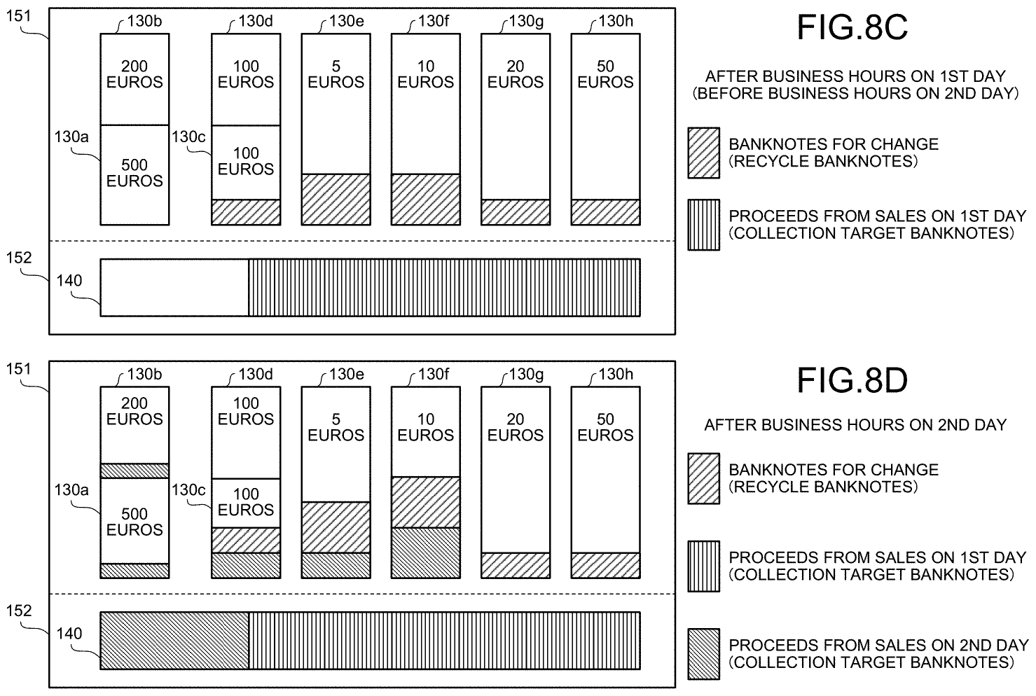

FIGS. 8A to 8D are schematic diagrams illustrating an example of the banknote handling process performed in the banknote handling apparatus 1. In FIGS. 8A to 8D, since the banknote storage states in the storage units 130 and the collection container 140 are to be described, only the components necessary for the description are schematically shown while the other components are omitted.

As shown in FIG. 8A, before business hours of the store, banknotes (change fund) to be used as change at the checkout counter are stored in the storage units 130 of the banknote handling apparatus 1, while no banknotes are stored in the collection container 140 that does not feed out banknotes but stores banknotes.

Denominations of banknotes to be stored in the storage units 130 are assigned to each of eight storage units 130 in advance. The number of banknotes for change is set for each denomination in advance. Information of the denomination assigned to each storage unit 130 and information of the number of banknotes for change for each denomination are previously prepared in the setting information 113 in the memory 110. Banknotes for change, the denomination and the number of which have been set in advance, are stored in the storage unit 130 corresponding to the denomination. Before the business hours of the store, the clerk performs, with the banknote handling apparatus 1, the dispensing process for dispensing banknotes to be used as change at the checkout counter. The control unit 100 feeds out banknotes to be dispensed, from corresponding storage unit 130 to the transport path, and transports the banknotes to the cassette 20 or the dispensing unit 40. The clerk carries the banknotes stored in the cassette 20 or the banknotes discharged from the dispensing unit 40 to the checkout counter, and uses the banknotes as change for transactions.

During the business hours of the store, when shortage and/or surplus of banknotes has occurred at the checkout counter, the dispensing process and/or the depositing process are performed in the banknote handling apparatus 1. In the case of shortage of banknotes for change at the checkout counter, the clerk performs dispensing of banknotes for change by using the banknote handling apparatus 1. Then, as described with reference to FIG. 5, banknotes to be dispensed are fed out from the storage unit 130 and discharged from the apparatus 1. In the case of surplus of banknotes at the checkout counter, the clerk performs depositing of banknotes collected from the checkout counter, by using the banknote handling apparatus 1. Then, as described with reference to FIG. 4, deposited banknotes are stored in the storage units 130. In each storage unit 130, recycling is performed such that the banknotes deposited in the depositing process are dispensed in the dispensing process. During the business hours of the store, the storage units 130 are used for storing recycle banknotes as shown in FIG. 8B.

A banknote, which is determined by the control unit 100 not to be recyclable from among the banknotes deposited in the depositing process, is stored in the collection container 140. In addition, a banknote which can be deposited in the banknote handling apparatus 1 but the denomination of which is not assigned to any of the storage unit 130, and a banknote which is to be stored in a storage unit 130 but cannot be stored because the storage unit 130 is full, are also stored in the collection container 140. As shown in FIG. 8B, the collection container 140 is used for storing banknotes that are not recycled but collected.

After the business hours of the store, the banknotes are collected from the checkout counters and other places and deposited in the banknote handling apparatus 1. When the clerk has finished the depositing process and performed a predetermined operation on the operation unit 10, the proceeds from sales of the store on the first day are confirmed, and the collection process is started. An amount obtained by subtracting the amount of banknotes having been present in the store from the start of the business hours (banknotes for change in FIG. 8A) from the total amount of banknotes being stored in the banknote handling apparatus 1 is the proceeds from sales. The proceeds from sales are calculated by the control unit 100. When the proceeds from sales have been confirmed, the control unit 100 determines the denominations and the number of banknotes for each denomination constituting the proceeds from sales. The banknotes constituting the proceeds from sales thus determined are collection target banknotes. For example, the denominations and the number for each denomination of collection target banknotes to be transported from the storage units 130 to the collection container 140 are determined based on: the amount of the proceeds from sales; the total amount of banknotes already stored in the collection container 140 as shown in FIG. 8B; and the denominations and the number for each denomination of banknotes for change to be left and used for the next business day.

Based on the determination result, the control unit 100 controls the storage unit 130 to feed out, to the transport path, the collection target banknotes constituting the proceeds from sales (hereinafter referred to as “banknotes from sales”) out of the banknotes being stored in the storage unit 130. The banknotes fed out from the storage unit 130 are transported along the transport path and stored in the collection container 140 as shown in FIGS. 7A to 7C. Specifically, while the banknotes for change necessary for the next business day are left in the storage units 130, the remaining banknotes are collected into the collection container 140. In the collection container 140, the banknotes from sales are stored in a denomination mixed state.

After the collection process has ended, each storage unit 130 is in the state where the banknotes for change to be used for the next business day are stored as shown in FIG. 8C, like as in the state before the business hours of the first day shown in FIG. 8A. Meanwhile, the collection container 140 is in the state where the banknotes from sales (a banknote group equivalent to the amount of the proceeds from sales) are stored therein. Business hours of the store on the second day are started in the state shown in FIG. 8C.

Conventionally, during the business hours on the second day, the clerk has to predict whether all the banknotes from sales on the second day can be stored in the collection container 140 or not after the business hours on the second day, based on the number of banknotes storable in the collection container 140, the expected number of the banknotes from sales on the second day based on his/her experiences in the store, and the like. If the clerk has determined that not all the banknotes from sales can be stored in the collection container 140 after the business hours on the second day, the clerk needs to request the CIT company for collecting, from the store, the collection container 140 in which banknotes are stored. Upon receiving the request, the person in charge of the CIT company visits the store with an empty collection container 140, collects the collection container 140 in which a plurality of banknotes including the banknotes from sales on the first day are stored, and mounts the empty collection container 140 to the banknote handling apparatus 1. In this case, the clerk makes the request to the CIT company after confirming the amount of banknotes being stored in the collection container 140, i.e., the amount of banknotes to be collected by the CIT company. Therefore, after the request has been made to the CIT company, banknotes cannot be stored in the collection container 140 to avoid changing the confirmed amount of banknotes in the collection container 140 until the collection container 140 is collected. Consequently, the clerk cannot perform the banknote handling process such as depositing process by using the banknote handling apparatus 1. The banknote handling apparatus 1 according to the present embodiment has one feature that the clerk can continue to use the banknote handling apparatus 1 regardless of the number of the banknotes in the collection container 140, even after the collection container 140 has become full of banknotes.

When the business hours on the second day have started in the state shown in FIG. 8C, banknotes for change necessary for the business on the second day are prepared in the storage units 130. Therefore, the banknote handling apparatus 1 can perform the dispensing process in which the banknotes for change in the storage units 130 are transported to the dispensing unit 40 or the cassette 20.

During the business hours on the second day, the clerk can perform dispensing of banknotes for change and depositing of banknotes from sales by using the banknote handling apparatus 1 as in the first day. After the business hours on the second day, as in the first day, the clerk collects banknotes present in the store, deposits these banknotes in the banknote handling apparatus 1 to confirm the proceeds from sales of the store on the second day, and performs the collection process. In the collection process, as in the first day, the control unit 100 starts to feed out the banknotes from sales on the second day from the storage unit 130, and store the banknotes into the collection container 140. If the collection container 140 becomes full of banknotes in the middle of the process, the control unit 100 keeps the remaining banknotes from sales in the storage units 130 as shown in FIG. 8D.

Specifically, in the banknote handling apparatus 1, the banknotes for change necessary for the next business day are left in the storage units 130 as in the state before the business hours on the second day, and the banknotes from sales of the second day are dividedly stored in the collection container 140 and at least one storage unit 130. In the collection container 140, the banknotes from sales on the first day and a part of the banknotes from sales on the second day are stored in a denomination mixed state. In the at least one storage unit 130, the banknotes from sales on the second day and the banknotes for change to be used on the third day are stored by denominations. That is, this storage unit 130 stores both collection target banknotes and recycle banknotes. The control unit 100 stores information indicating the storage states of these banknotes, in the inventory information 111 and the collection information 112 in the memory 110. The collection information 112 includes information indicating that a part of the banknotes from sales are stored in the storage unit 130.

The business hours on the third day start with the banknotes constituting the proceeds from sales on the second day being dividedly stored in the collection container 140 and the storage units 130 as shown in FIG. 8D. During the business hours on the third day, as in the first day and the second day, the clerk can perform the banknote handling process by using the banknote handling apparatus 1. That is, the clerk can continue to use the banknote handling apparatus 1. When performing the dispensing process, the control unit 100 does not dispense the banknotes from sales but dispenses banknotes (recycle banknotes) other than the banknotes from sales, from the storage unit 130. For example, if the amount of banknotes from sales is 100,000 yen in a storage unit 130 in which banknotes totaling 500,000 yen are stored, the dispensing process is performed by using banknotes of the remaining 400,000 yen.

According to kinds of the banknotes deposited and dispensed during the business hours on the third day, the control unit 100 can perform exchange between banknotes from sales and recycle banknotes. For example, if a large-denomination banknote that can be exchanged for small-denomination banknotes from sales is deposited, the control unit 100 regards the deposited large-denomination banknote as a banknote from sales, and changes some small-denomination banknotes from sales equivalent to the amount of the deposited large-denomination banknote, to recycle banknotes.

For example, if one 200-euro banknote is stored in the storage unit 130b in the depositing process, the control unit 100 exchanges this 200-euro banknote to be used as a recycle banknote for twenty 10-euro banknotes stored as banknotes from sales. Specifically, the control unit 100 regards the deposited one 200-euro banknote as a banknote from sales, and changes, instead of this banknote, twenty 10-euro banknotes having been regarded as banknotes from sales, to recycle banknotes. Thus, the number of 10-euro banknotes that can be dispensed in the dispensing process is increased by 20.

Settings that allow the control unit 100 to specify a denomination of deposited banknotes that can be regarded as proceeds from sales and a denomination for which banknotes from sales can be changed to recycle banknotes, are included in setting information 113 in the memory 110 in advance.

For example, the clerk, by operating the operation unit 10, can create settings by selecting a denomination of banknotes to be regarded as proceeds from sales in depositing processes and a denomination for which banknotes from sales are changed to recycle banknotes, and store the settings in the setting information 113 in the memory 110.

Alternatively, for example, the clerk can store, in the setting information 113 in the memory 110, settings that allow the control unit 100 to automatically select a denomination for which banknotes from sales are changed to recycle banknotes. In this case, based on transitional change in the number of banknotes for each denomination on the day, the control unit 100 specifies a denomination of recycle banknotes that are likely to run short on the day, and automatically selects the specified denomination as a denomination for which banknotes from sales are returned to recycle banknotes. If a banknote of a denomination, which is exchangeable for banknotes of the automatically selected denomination and is larger than the automatically selected denomination, is deposited, the control unit 100 changes, instead of the deposited banknote, the banknotes of the automatically selected denomination from the banknotes from sales to the recycle banknotes.

As described above, based on the settings prepared in advance in the setting information 113 stored in the memory 110, the control unit 100 can perform exchange between banknotes from sales to be collected and recycle banknotes to be used for the dispensing process. After performing the banknote exchange, the control unit 100 updates related information such that the inventory information 111 and the collection information 112 stored in the memory 110 coincide with the banknote storage state of the storage unit 130 after the banknote exchange.

[Example 2 of Banknote Handling Process of Storing Collection Target Banknotes in Storage Unit]

Although both banknotes from sales and recycle banknotes are stored in at least one storage unit 130 in the example shown in FIG. 8D, some storage unit 130 may be exclusively used for storing banknotes from sales so that banknotes from sales are not stored in storage units 130 that is storing recycle banknotes.

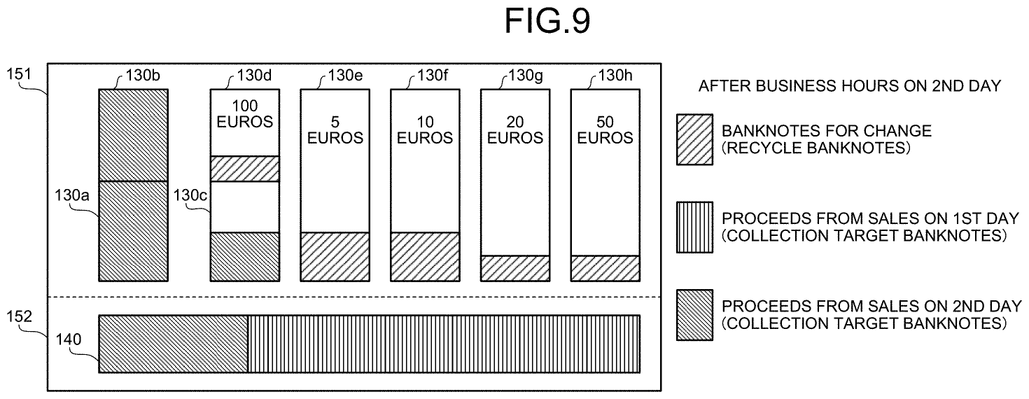

FIG. 9 is a schematic diagram illustrating an example of a banknote handling process in which storage units 130a to 130c are exclusively used for collection target banknotes. In FIG. 9, since the banknote storage states in the storage units 130 and the collection container 140 are to be described, only the components necessary for the description are schematically shown while the other components are omitted.

For example, the clerk stores, in the setting information 113 in the memory 110, a setting indicating that, if the collection container 140 becomes full of banknotes, the storage units 130a to 130c are exclusively used for the collection process of banknotes. In this case, after the business hours on the first day have started, the banknote handling process is performed as shown in FIGS. 8A and 8B. After the business hours on the first day, the collection process is performed, and therefore, the business hours on the second day start with all the banknotes from sales on the first day being stored in the collection container 140 as shown in FIG. 8C.

After the business hours on the second day, the collection process is started, and then, the control unit 100 recognizes that not all the banknotes from sales on the second day can be stored in the collection container 140. The control unit 100 changes the settings of the storage units 130a to 130c from a storage unit for storing recycle banknotes for each denomination as shown in FIGS. 8A to 8D to a storage unit for storing only banknotes from sales” as shown in FIG. 9.

The control unit 100 updates the settings related to the banknotes to be stored in the storage units 130a to 130c, to the changed settings, in the setting information 113 in the memory 110. After the update, the storage units 130a to 130c are used as banknote collection units.

As shown in FIG. 9A, after the collection process has ended, a part of the banknotes from sales on the second day are stored in the collection container 140 while the remaining banknotes, which could not be stored in the collection container 140, are stored in the storage units 130a to 130c set to be used as the banknote collection units. The collection container 140 and the storage units 130a to 130c each store the banknotes from sales in a denomination mixed state, while the storage units 130d to 130h do not store banknotes from sales and store only banknotes for change, i.e., dispensable recycle banknotes, for each denomination.

The business hours on the third day start in the state shown in FIG. 9. During the business hours on the third day, the clerk can perform dispensing of banknotes for change and depositing of banknotes from sales by using the banknote handling apparatus 1, as in the first day and the second day. When performing the dispensing process, the control unit 100 dispenses the banknotes stored in the storage units 130d to 130h, and does not dispense the banknotes from sales stored in the storage units 130a to 130c.

In FIG. 9, the usage of the three storage units 130a to 130c is changed from storage units to collection units. However, the number of storage units 130 for which the usage is changed is not particularly limited. For example, if all the banknotes from sales can be stored by using one storage unit 130a as a collection unit, only this storage unit 130a may be used as a collection unit.

[Example 3 of Banknote Handling Process of Storing Collection Target Banknotes in Storage Unit]

In the banknote handling process shown in FIGS. 8A to 8D, all the storage units 130 are assigned, in advance, denominations of banknotes to be stored therein. However, there are cases where a storage unit 130 is not assigned a denomination and is used as a storage unit for inventory confirmation. FIGS. 10A and 10B are schematic diagrams illustrating an example of a banknote handling process in which storage units 130a, 130b are used for the inventory confirmation process. In this example, two storage units 130a, 130b are allocated to the inventory confirmation process. In FIGS. 10A and 10B, since the banknote storage states in the storage units 130 and the collection container 140 are to be described, only the components necessary for the description are schematically shown while the other components are omitted.

As shown in FIG. 10A, the business hours of the store on the first day start in the state where the storage units 130c to 130h are assigned denominations, and banknotes for change are prepared in these storage units 130c to 130h. During the business hours of the store, the banknote handling apparatus 1 can perform the depositing process of storing banknotes into the storage units 130c to 130h, and the dispensing process of dispensing banknotes from the storage units 130c to 130h. Furthermore, the banknote handling apparatus 1 can perform the inventory confirmation process as described with reference to FIG. 6 by using the storage units 130a, 130b.

After the business hours on the first day, the collection process is performed, and the business hours on the second day start in the state where all the banknotes from sales are stored in the collection container 140 while the banknotes for change are stored in the storage units 130c to 130h as in the case of FIG. 8C. During the business hours on the second day, the banknote handling process is performed as in the first day. After the business hours on the second day, the collection process is started. If the control unit 100 recognizes that not all the banknotes from sales on the second day can be stored in the collection container 140, the control unit 100 changes settings such that the two empty storage units 130a, 130b having been allocated to the inventory confirmation process are used for storing the banknotes from sales. That is, the usage of the storage units 130a, 130b is changed to banknote collection units. The control unit 100 stores the banknotes from sales on the second day into the collection container 140 and the storage units 130a, 130b set to be used as the banknote collection units.

After the collection process of the second day has ended, a part of the banknotes from sales on the second day are stored in the collection container 140, and the remaining banknotes from sales, which could not be stored in the collection container 140, are stored in the storage units 130a, 130b as shown in FIG. 10B. If the collection container 140 and the two storage units 130a, 130b cannot store all the banknotes from sales, a part of the banknotes from sales can be stored in at least one of the remaining storage units 130c to 130h as described with reference to FIG. 8D.

The business hours on the third day start with the banknotes for change being stored in the storage units 130c to 130h as shown in FIG. 10B. The control unit 100 performs the depositing process and the dispensing process while recycling the banknotes stored in the storage units 130c to 130h. The banknotes from sales stored in the storage units 130a, 130b are not recycled, and therefore are not used for the dispensing process.

In FIGS. 10A and 10B, the usage of the two storage units 130a, 130b is changed from storage units for inventory confirmation to banknote collection units. However, the number of storage units 130 for which the usage is changed is not particularly limited. For example, if all the banknotes from sales can be stored by using one storage unit 130a as a banknote collection unit, only this storage unit 130a may be used as a banknote collection unit.

For example, in order to enable the inventory confirmation process, the banknotes from sales may not be stored in the storage unit 130a out of the plurality of storage units 130a, 130b set for inventory confirmation process, and only the usage of the remaining storage unit 130b may be changed to a collection unit.

Alternatively, for example, the banknotes from sales may not be stored in the storage units 130a, 130b set for inventory confirmation process, and the banknotes from sales and the recycle banknotes may be stored in the remaining storage units 130c to 130h.

If the storage units 130 set for inventory confirmation process are ensured even after the collection process has been performed, the inventory confirmation process can be performed according to need while dividedly storing the banknotes from sales in the collection container 140 and at least one storage unit 130.

[Container Collection Process]

The determination condition for determining whether or not to request a CIT company for collection of proceeds from sales is stored in the setting information 113 in the memory 110. The clerk can register the determination condition in the setting information 113 by operating the operation unit 10. For example, the clerk sets the determination condition such that, when a part of banknotes from sales have been stored in a storage unit 130 after the business hours of the store and the total number of these banknotes for change and banknotes from sales in this storage unit 130 exceeds a predetermined number (threshold number), a request for collection of banknotes is made to the CIT company. Alternatively, for example, the clerk may set the determination condition such that a request for collection of banknotes is made to the CIT company if the total number of banknotes for change and banknotes from sales in the storage unit 130 exceeds a predetermined percentage of the maximum number of banknotes storable in the storage unit 130.

The clerk may also set the determination condition, based on the number of banknotes from sales for which collection is requested to the CIT company, and on the maximum number of banknotes storable in the collection container 140. For example, the clerk sets the determination condition such that a request for collection of banknotes is made to the CIT company when the number of banknotes from sales (collection target banknotes) has reached 5,400 corresponding to 1.8 times the capacity of the collection container 140 capable of storing 3,000 banknotes at maximum.

For example, after the collection process has been performed, the control unit 100 determines whether or not the banknote storage state satisfies the determination condition set by the clerk in advance. If the condition is satisfied, the control unit 100 performs the notification process of requesting the CIT company for the collection of banknotes. The notification process is performed by using the communication unit 120. In the notification process, a collection requesting notification, and information on the banknotes from sales to be collected are transmitted to the communication terminal used by the CIT company. The information on the banknotes from sales includes: information indicating the denominations of the banknotes to be collected from the store, the number of banknotes for each denomination, and the total number and the total amount of the banknotes; and information indicating the number of collection containers 140 necessary for the collecting the banknotes. For example, if two collection containers 140 are necessary for collecting the proceeds from sales of the store from the banknote handling apparatus 1, the CIT company is requested, in the notification, to come to the store with two collection containers 140 for collecting the banknotes.

Upon receiving the request from the store, the person in charge of the CIT company (hereinafter simply referred to as “person in charge”) heads to the store with the requested number of collection containers 140. The person in charge having arrived at the store operates the operation unit 10 of the banknote handling apparatus 1 to start the container collection process.

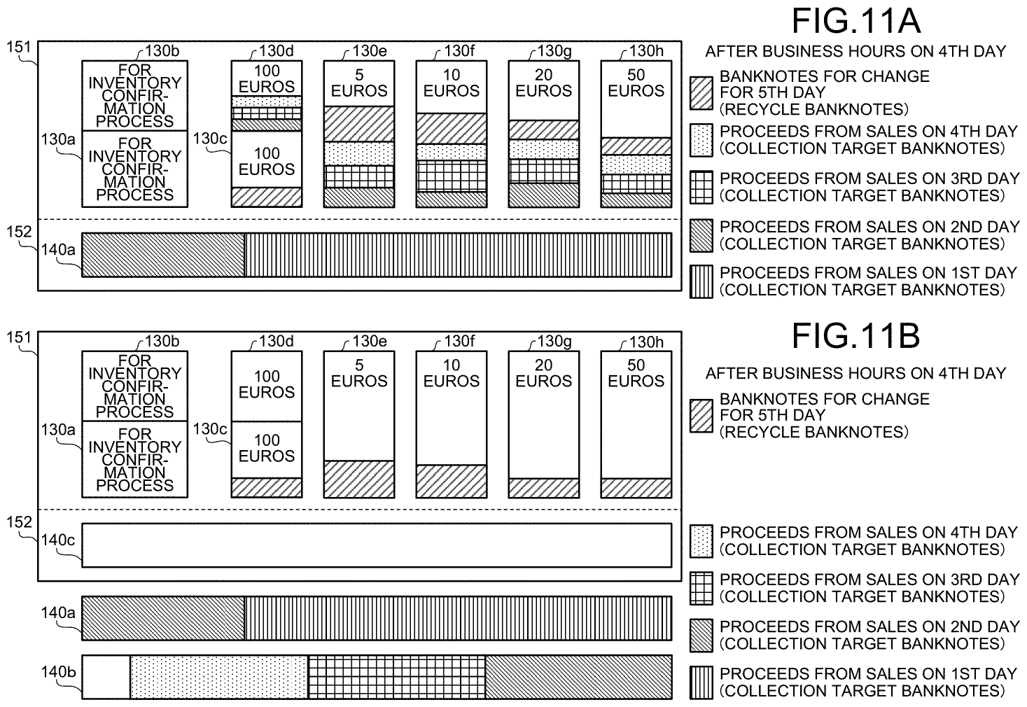

The container collection process to be performed after the business hours on the fourth day will be described. FIGS. 11A and 11B are schematic diagrams illustrating the container collection process performed in the banknote handling apparatus 1. In FIGS. 11A and 11B, since the banknote storage states in the storage units 130 and the collection container 140 are to be described, only the components necessary for the description are schematically shown while the other components are omitted. FIG. 11A shows the banknote storage state before the container collection process is started after the business hours on the fourth day. FIG. 11B shows the banknote storage state after the container collection process has ended.

As shown in FIG. 11A, after the business hours on the fourth day, banknotes from sales on the first day and a part of banknotes from sales on the second day are stored in the collection container 140a. In the example shown in FIGS. 11A and 11B, the storage units 130a, 130b are kept empty to be used for the inventory confirmation process. Therefore, as shown in FIG. 11A, banknotes are not stored in these storage units 130a, 130b.

Recycle banknotes and banknotes from sales are stored in the storage units 130c to 130h which are set to store recycle banknotes for change for each denomination. For example, as for “100-euro banknote” for which two storage units 130c, 130d are allocated as shown in FIG. 11A, the recycle banknotes of this denomination are stored in one storage unit 130c while the banknotes from sales from the second day to the fourth day are stored in the other storage unit 130d. As for other denominations which are respectively assigned to the storage units 130e to 130h, both the recycle banknotes and the banknotes from sales from the second day to the fourth day are stored in each of the storage units 130e to 130h. The banknote handling apparatus 1 can perform the banknote handling process including the depositing process and the dispensing process by using the recycle banknotes while the banknotes from sales for a plurality of days are stored and kept in the storage units 130d to 130h.

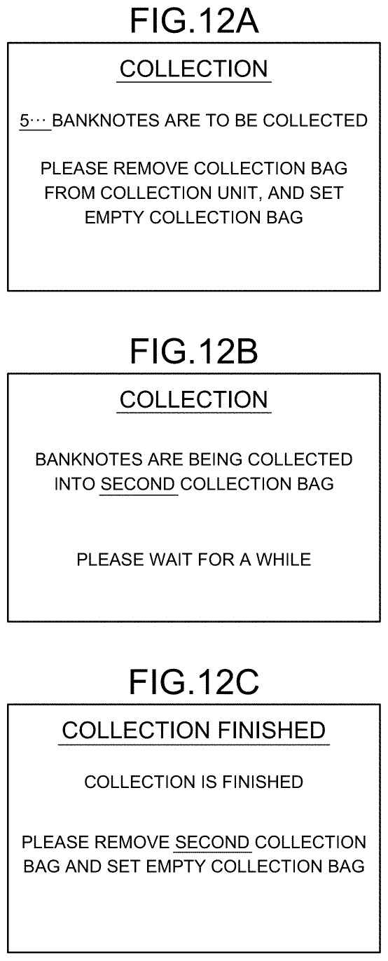

When the person in charge of the CIT company has started the container collection process in the state shown in FIG. 11A, information guiding the content of work to be performed by the person in charge is displayed on the screen of the operation unit 10. FIGS. 12A to 12C show examples of the screen of the operation unit 10 during the container collection process. After the container collection process has started, the number of banknotes from sales to be collected, and an instruction for the person in charge are displayed on the screen of the operation unit 10 as shown in FIG. 12A.

The person in charge having checked the screen shown in FIG. 12A dismounts, from the banknote handling apparatus 1, the collection container 140a full of banknotes from sales as shown in FIG. 11A, and mounts, to the collection unit 141, the empty collection container 140b he/she has brought to the store.

When the container collection process has started, the control unit 100 recognizes that the banknotes from sales from the second day to the fourth day are stored in the storage units 130d to 130h as shown in FIG. 11A, based on the collection information 112 stored in the memory 110. After the empty collection container 140b is mounted to the collection unit 141, the control unit 100 feeds out the banknotes from sales from the storage units 130d to 130h, and transports these banknotes as shown in FIG. 7A to store them in the collection container 140b. Meanwhile, information indicating that the banknotes are being stored in the second collection container 140b (second collection bag) is displayed on the operation unit 10 as shown in FIG. 12B.

After the banknotes from sales stored in the storage units 130c to 130h have been collected in the collection container 140b, the control unit 100 displays information notifying this on the screen of the operation unit 10 as shown in FIG. 12C. The person in charge dismounts, from the banknote handling apparatus 1, the second collection container 140b (second collection bag) in which the banknotes from sales are being stored, and mounts, to the collection unit 141, the empty collection container 140c he/she has brought to the store. After the empty collection container 140c has been mounted to the collection unit 141, the control unit 100 ends the container collection process.

When the container collection process has ended, the collection container 140c mounted to the banknote handling apparatus 1 is empty, and only the recycle banknotes for change are stored in the storage unit 130 as shown in FIG. 11B. Meanwhile, the banknotes from sales for a plurality of days are stored in the two collection containers 140a, 140b collected to outside the banknote handling apparatus 1.

The person in charge having finished the container collection process carries the two collection containers 140a, 140b in which the proceeds from sales of the store from the first day to the fourth day are being stored as shown in FIG. 11B, out from the store. The person in charge carries the two collection containers 140a, 140b from the store to a predetermined place. For example, the proceeds from sales are carried to a cash center where banknotes collected from a plurality of stores are handled.

[Inventory Confirmation Process During Transport of Banknotes]

The banknote handling apparatus 1 can store both banknotes from sales and recycle banknotes in one storage unit 130. In the container collection process, the collection container 140 in which banknotes from sales are stored is dismounted from the banknote handling apparatus 1 and collected to outside the apparatus 1, and thereafter, an empty collection container 140 is mounted to the collection unit 141. The control unit 100 feeds out the remaining banknotes from sales out of the banknotes being stored in the storage unit 130, and transports the fed-out banknotes to the empty collection container 140.

If the storage unit 130 for inventory confirmation is present inside the banknote handling apparatus 1 as shown in FIGS. 11A and 11B, the control unit 100 can perform the inventory confirmation process when the banknotes from sales are transported in the container collection process. The clerk can select one of: a first method of transporting the banknotes from sales to the storage unit 130 for inventory confirmation process, and then collecting these banknotes into the collection container 140; and a second method of directly collecting the banknotes from sales into the collection container 140. Hereinafter, the first method and the second method will be described. In the description, a storage unit in which the banknotes from sales, i.e., collection target banknotes, are stored is denoted by 130, and a storage unit for inventory confirmation is denoted by 131.

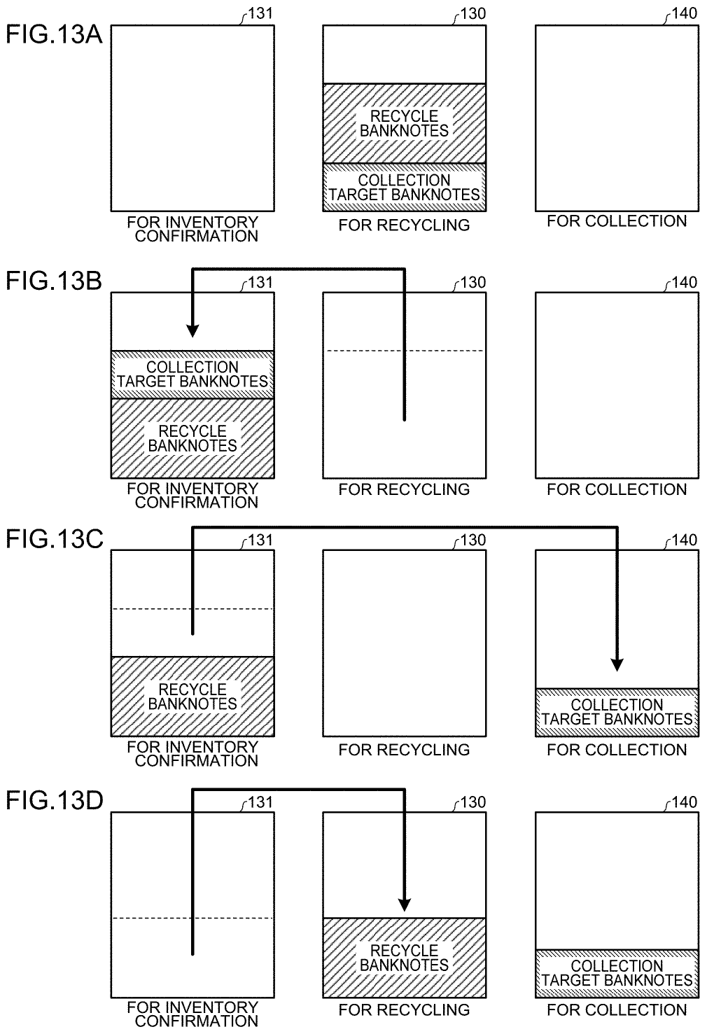

FIGS. 13A and 13D are schematic diagrams illustrating the first method of transporting the collection target banknotes in the storage unit 130 to the storage unit 131 for inventory confirmation process, and then collecting these banknotes into the collection container 140. The control unit 100 feeds out all the banknotes stored in the storage unit 130 as shown in FIG. 13A one by one, checks the banknotes by using the recognition unit 80. The control unit 100 stores these banknotes in the storage unit 131 for inventory confirmation process as shown in FIG. 13B. The control unit 100 stores all the banknotes fed out from the storage unit 130 into the storage unit 131 to end the inventory confirmation process. The control unit 100 having ended the inventory confirmation process feeds out the collection target banknotes from the storage unit 131 and stores these banknotes in the collection container 140 as shown in FIG. 13C. Subsequently, the control unit 100 feeds out the recycle banknotes from the storage unit 131 and returns these banknotes to the original storage unit 130 as shown in FIG. 13D. Thus, through the inventory confirmation process, the control unit 100 can confirm that the banknotes actually stored in the storage unit 131 coincide with the information managed in the inventory information 111 and the collection information 112 stored in the memory 110, and simultaneously, the control unit 100 can store the collection target banknotes, which has been stored in the storage unit 130 before the inventory confirmation process, in the collection container 140.

If the result of the inventory confirmation process indicates that the banknotes which have been actually stored in the storage unit 131 is insufficient unlike the information managed in the memory 110, how to deal with this insufficiency can be changed by setting.

If the setting is prepared such that the insufficiency should be dealt with as insufficiency in the recycle banknotes, the control unit 100 secures the collection target banknotes in the collection container 140 to make coincidence with the information in the memory 110, in the banknote transport shown in FIG. 13C. Thereafter, in the transport shown in FIG. 13D, the control unit 100 returns the remaining banknotes to the storage unit 130 as recycle banknotes. Meanwhile, if the setting is prepared such that the insufficiency should be dealt with as insufficiency in the collection target banknotes, the control unit 100 secures, in the storage unit 131, the recycle banknotes to be returned to the storage unit 130 to make coincidence with the information in the memory 110. Then, in the transport shown in FIG. 13C, the control unit 100 stores a certain number of banknotes, obtained by subtracting the number of the secured recycle banknotes from the number of the banknotes stored in the storage unit 131, in the collection container 140 to be used as collection target banknotes. Thereafter, the control unit 100 returns the recycle banknotes secured in the storage unit 131 to the storage unit 130, in the transport shown in FIG. 13D.

For example, if the result of the inventory confirmation process indicates that only 299 banknotes are actually stored in the storage unit 130 although a total of 300 banknotes (=100 banknotes from sales+200 recycle banknotes) should be stored in the storage unit 130, and this insufficiency is dealt with as a recycle banknote, 100 banknotes from sales are stored as planned in the collection container 140, and 199 recycle banknotes are stored in the storage unit 130. On the other hand, when the insufficiency is dealt with as a banknote from sales, 200 recycle banknotes are stored as planned in the storage unit 130, and 99 banknotes from sales are stored in the collection container 140.

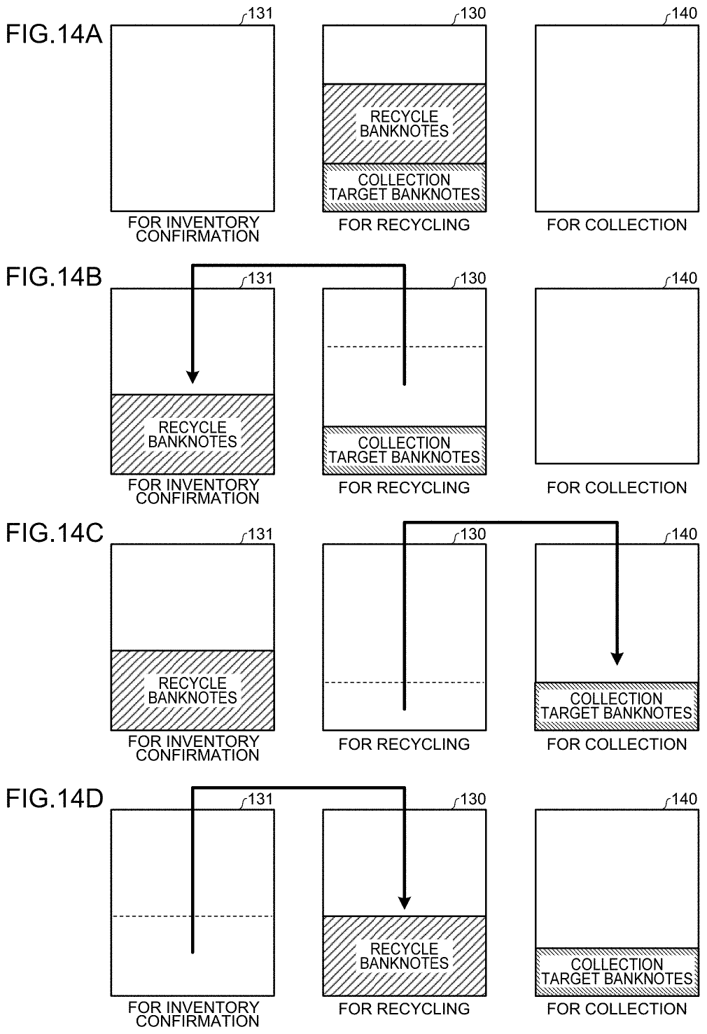

FIGS. 14A to 14D are schematic diagrams illustrating the second method of directly collecting collection target banknotes from the storage unit 130 to the collection container 140. The control unit 100 feeds out banknotes stored in the storage unit 130 as shown in FIG. 14A one by one, checks the banknotes by using the recognition unit 80, and stores the banknotes in the storage unit 131 for inventory confirmation process as shown in FIG. 14B. The control unit 100 having stored all recycle banknotes into the storage unit 131, feeds out the remaining banknotes from the storage unit 130 one by one, checks the banknotes by using the recognition unit 80, and stores the banknotes in the collection container 140 as shown in FIG. 14C. The control unit 100 feeds out all the banknotes from the storage unit 130 to end the inventory confirmation process.

Subsequently, the control unit 100 feeds out all the banknotes from the storage unit 131 and returns the banknotes to the original storage unit 130 as shown in FIG. 14D. Thus, through the inventory confirmation process, the control unit 100 can confirm that the banknotes actually stored in the storage unit 131 coincide with the information managed in the inventory information 111 and the collection information 112 stored in the memory 110, and simultaneously, the control unit 100 can store the collection target banknotes in the collection container 140.

If the setting is prepared such that insufficiency in the inventory confirmation process should be dealt with as insufficiency in the collection target banknotes, the control unit 100 secures the recycle banknotes in the storage unit 131 to make coincidence with the information in the memory 110, in the transport shown in FIG. 14B. Thereafter, the control unit 100 stores the remaining banknotes in the storage unit 130 into the collection container 140, in the transport shown in FIG. 14C. Meanwhile, if the setting is prepared such that insufficiency should be dealt with as insufficiency in the recycle banknotes, the control unit 100 firstly transports banknotes from the storage unit 130 to the collection container 140 as shown in FIG. 14C to secure the collection target banknotes in the collection container 140 and make coincidence with the information in the memory 110. Thereafter, the control unit 100 transports remaining banknotes from the storage unit 130 to the storage unit 131 as shown in FIG. 14B. In either case, the banknotes in the storage unit 131 are thereafter returned to the storage unit 130 in the transport shown in FIG. 14D.

For example, based on the inventory information 111 and the collection information 112 stored in the memory 110, the control unit 100 recognizes that a total of 300 banknotes (=100 banknotes from sales to be collected+200 recycle banknotes) are stored in the storage unit 130. However, the number of banknotes actually stored in the storage unit 130 is 299. If this insufficiency is to be dealt with as a banknote from sales, after 200 banknotes are transported as planned from the storage unit 130 to the storage unit 131, the remaining 99 banknotes are stored in the collection container 140. Thereafter, 200 banknotes in the storage unit 131 are returned to the storage unit 130. On the other hand, if the insufficiency is to be dealt with as a recycle banknote, after 100 banknotes are transported as planned from the storage unit 130 to the collection container 140, the remaining 199 banknotes are transported from the storage unit 130 to the storage unit 131 and thereafter are returned to the storage unit 130.

[Confirmation of Banknote Information]

The control unit 100 can display, on the operation unit 10, information on the banknotes stored in the respective storage units 130 and information on the banknotes stored in the collection container 140, based on the inventory information 111 and the collection information 112 managed in the memory 110. The clerk and the person in charge of the CIT company can confirm, on the screen of the operation unit 10, the information on the banknotes stored in the banknote handling apparatus 1.

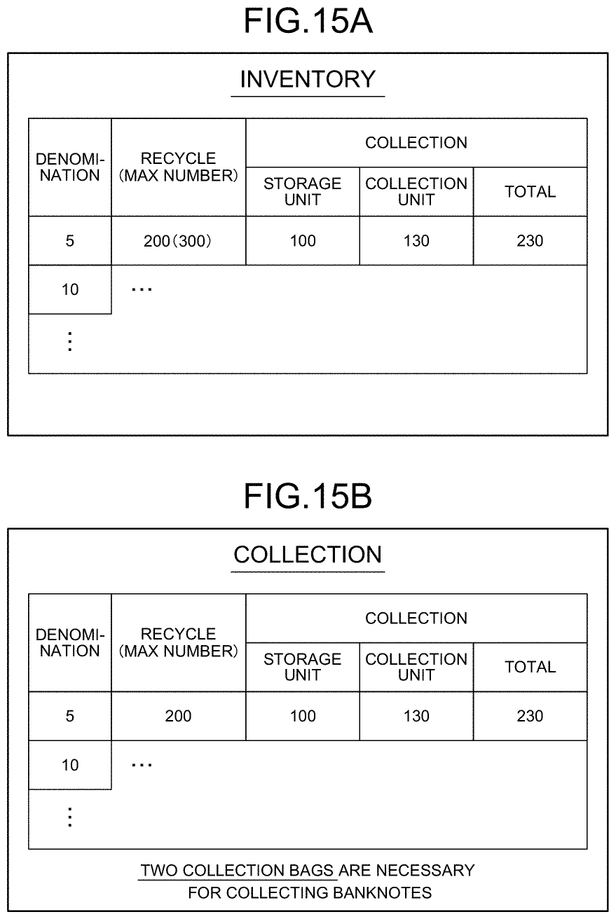

FIGS. 15A and 15B show examples of banknote information displayed on the screen of the operation unit 10. FIG. 15A shows an example of an inventory confirmation screen that allows the clerk to confirm information on the banknotes stored in the banknote handling apparatus 1.

On the inventory confirmation screen, items of “denomination”, “recycle”, and “collection” are displayed. The item of “collection” includes items of “storage unit”, “collection unit”, and “total”. Under the item of “denomination”, denominations of banknotes stored in the banknote handling apparatus 1 are displayed. Under the item of “recycle”, the number of recycle banknotes out of the banknotes stored in the banknote handling apparatus 1 is displayed. When a part of the banknotes stored in the storage unit 130 is regarded as proceeds from sales to be collected as shown in FIG. 8D, the number of banknotes (recycle banknotes) other than the collection target banknotes (banknotes from sales) is displayed under the item of “recycle”.

Under the item of “collection”, information on banknotes to be collected from the store is displayed. Under the item of “storage unit”, the number of collection target banknotes stored in the storage unit 130 as shown in FIG. 8D is displayed. Under the item of “collection unit”, the number of collection target banknotes stored in the collection container 140 is displayed. Under the item of “total”, the total number of these banknotes is displayed.

FIG. 15A shows that 300 5-euro banknotes are stored in the storage unit 130, and 200 banknotes out of the 300 banknotes are recycle banknotes and the remaining 100 banknotes are collection target banknotes. FIG. 15A further shows that a total of 230 5-euro banknotes (i.e., 100 5-euro banknotes stored in the storage unit 130+130 5-euro banknotes already stored in the collection container 140) are collection target banknotes.

Under the item of “recycle” shown in FIG. 15A, in addition to the number of recycle banknotes, the maximum number of recyclable banknotes is parenthesized. When 300 5-euro banknotes are stored in the storage unit 130 and 100 banknotes out of the 300 banknotes are stored as collection target banknotes, “200” is displayed under the item of “recycle” and “300” as the maximum number of recyclable banknotes is parenthesized.

The control unit 100 performs the banknote handling process while recycling 200 5-euro banknotes. In case of a certain emergency situation, the control unit 100 can perform the banknote handling process by using, as recycle banknotes, 100 5-euro banknotes being stored as collection target banknotes. Therefore, the maximum number of recycle banknotes being 300 is displayed on the screen of the operation unit 10. For example, after a notification for requesting delivery of 5-euro banknotes for change to the store was transmitted to the communication terminal of the CIT company, if the banknote handling apparatus 1 is not replenished with banknotes after a predetermined time period has elapsed, the control unit 100 determines that an emergency situation has occurred. The control unit 100 having determined the emergency situation continues the banknote handling process by using, as recycle banknotes, 100 5-euro banknotes that have been stored as collection target banknotes.

When collection target banknotes have been used as recycle banknotes, the control unit 100 compensates for the amount of the used banknotes with banknotes of another denomination stored in the banknote handling apparatus 1, or with banknotes newly stored in the banknote handling apparatus 1. For example, when four 5-euro banknotes having been stored as collection target banknotes are used in the dispensing process, the control unit 100 changes recycle banknotes of another denomination equivalent to the used 20 euros to collection target banknotes, and starts to keep these collection target banknotes inside the apparatus 1. For example, the control unit 100 changes two 10-euro banknotes, one 20-euro banknote, or the like having been stored as recycle banknotes, to collection target banknotes, and keeps these banknotes in the storage unit 130 without recycling them.

Alternatively, for example, the control unit 100 records the total amount, 20 euros, of the collection target banknotes used as recycle banknotes, and changes banknotes of a denomination the number of which has been increased due to depositing or replenishment, to collection target banknotes. For example, when the CIT company has arrived at the store and replenished the banknote handling apparatus 1 with banknotes and thereby the number of 5-euro banknotes in the storage unit 130 has been increased, the control unit 100 regards replenished four 5-euro banknotes as collection target banknotes and keeps them inside the apparatus 1. For another example, when a depositing process has been performed and one or a plurality of banknotes equivalent to 20 euros have been stored in the storage unit 130, the control unit 100 regards the newly deposited banknotes equivalent to 20 euros as collection target banknotes and keeps these banknotes inside the apparatus 1.

Although FIG. 15A shows an example of the screen including information on recycle banknotes and information on collection target banknotes, information to be displayed can be changed by setting. For example, information on collection target banknotes may not necessarily be displayed.

FIG. 15B shows an example of a screen displayed on the operation unit 10 when information on banknotes to be collected from the banknote handling apparatus 1 is confirmed. On the screen, items of “denomination”, “recycle”, and “collection” are displayed. The item of “collection” includes items of “storage unit”, “collection unit”, and “total”.

Under the item of “denomination”, denominations of banknotes to be collected from the banknote handling apparatus 1 are displayed. Under the item of “recycle”, the number of banknotes to be left in the banknote handling apparatus 1 without being collected from the apparatus is displayed. Under the item of “collection”, the number of collection target banknotes stored in the storage unit 130 is displayed under the item of “storage unit”, the number of collection target banknotes stored in the collection container 140 is displayed under the item of “collection unit”, and the total number of these banknotes is displayed under the item of “total”.

On a lower portion of the screen, the number of collection containers 140 required for collecting the banknotes to outside the banknote handling apparatus 1 is displayed. For example, when the clerk collects the banknotes from sales to outside the banknote handling apparatus 1 and hands over the banknotes to the CIT company, the clerk having checked the screen shown in FIG. 15B prepares two collection containers 140 and performs the container collection process as described with reference to FIGS. 11A, 11B and FIGS. 12A to 12C.

Although FIG. 15B shows the screen including information on recycle banknotes and information on collection target banknotes, information to be displayed can be changed by setting. For example, information of recycle banknotes may not necessarily be displayed.

[Handling of Serial Number]

A process in which the control unit 11 manages the serial numbers of banknotes stored in each storage unit 130 will be described. The control unit 100 performs OCR (Optical Character Recognition) on an image of a banknote obtained in the recognition unit 80 to recognize the serial number of the banknote. The control unit 100 stores information indicating the recognized serial number, in the inventory information 111 in the memory 110.

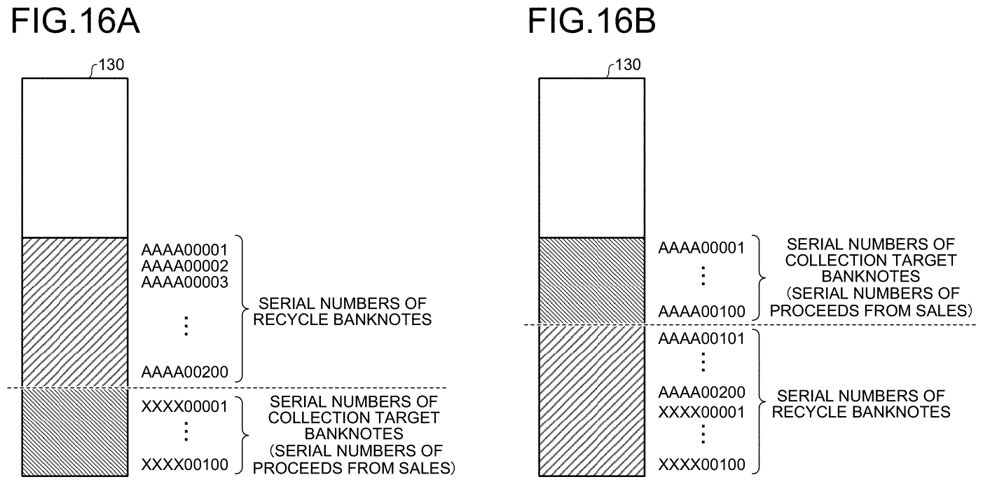

FIGS. 16A and 16B are schematic diagrams illustrating a banknote management method using serial numbers. The storage unit 130 stores a plurality of banknotes such that the banknotes are stacked with the faces thereof being substantially horizontal. The control unit 100 manages the serial numbers of the respective banknotes in the storage unit 130 in the stacking order as shown in FIG. 16A. In the depositing process, deposited banknotes are sequentially stacked on the banknotes already stacked in the storage unit 130. In the dispensing process, the banknotes in the storage unit 130 are fed out in order from the uppermost banknote to the transport path. Therefore, if collection target banknotes (banknotes from sales) and recycle banknotes are stored in the storage unit 130 as shown in FIG. 8D, the control unit 100 performs the banknote handling process such that the banknotes on the lower side are kept as collection target banknotes while the banknotes on the upper side are used as recycle banknotes.

In the container collection process in which the collection target banknotes stored in the storage unit 130 are transported to the collection container 140 and collected to outside the banknote handling apparatus 1, the banknotes in the storage unit 130 are fed out in order from the uppermost banknote to the transport path, and are stored in the collection container 140. Therefore, when the container collection process is started, the control unit 100 regards the upper-side banknotes as collection target banknotes in order from the uppermost banknote, and regards the lower-side banknotes as recycle banknotes, as shown in FIG. 16B.

For example, if 100 banknotes, which are on the lower side of the storage unit 130 and have the serial numbers of XXXX00001 to XXXX00100, are stored as collection target banknotes, and 200 banknotes, which have the serial numbers of AAAA00001 to AAAA00200, are stacked as recycle banknotes as shown in FIG. 16A, and the container collection process is started, 100 banknotes are fed out from the storage unit 130 in order from the uppermost banknote, are stored in the collection container 140, and are collected to outside the apparatus 1 by dismounting the collection container 140 from the collection unit 141. The control unit 100 having recognized the container collection process regards, as collection target banknotes, the 100 banknotes having the serial numbers of AAAA0001 to AAAA00100 in order from the uppermost banknote, and regards the 200 banknotes on the lower side as recycle banknotes, as shown in FIG. 16B.

As described above, since the control unit 100 specifies the serial numbers of the collection target banknotes to be stored in the collection container 140 in the container collection process, the control unit 100 can manage the serial numbers of all the banknotes in the collection container 140 to be collected by the CIT company. In case of trouble such as loss of banknotes, the serial numbers of banknotes can be used for investigation. [Property Right to Banknotes]

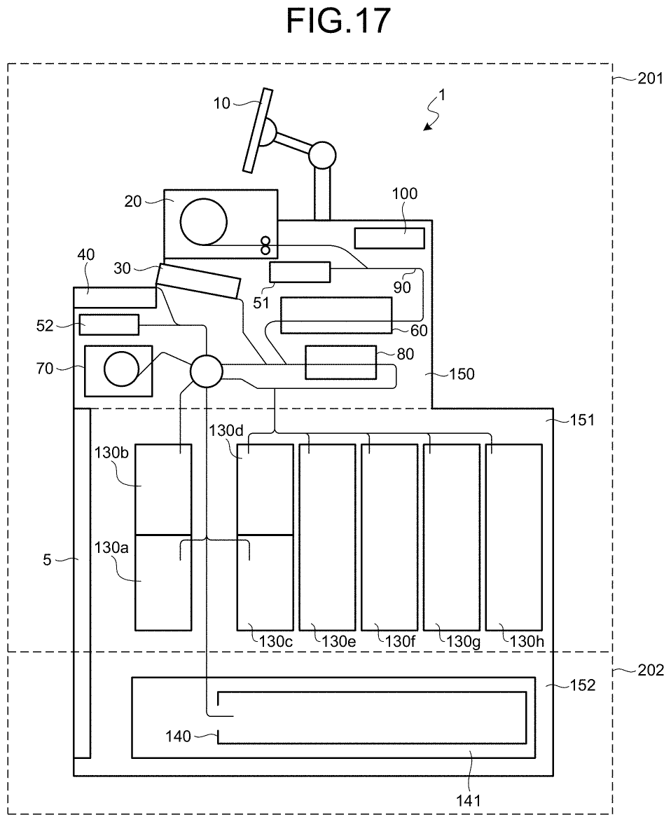

In the banknote handling apparatus 1, a property right to banknotes can be set. FIG. 17 is a diagram for describing the property right to banknotes. As shown by dashed rectangles in FIG. 17, the banknote handling apparatus 1 is divided into a first area 201 including the banknote handling unit 150 and the first safe unit 151, and a second area 202 including the second safe unit 152. A property right can be set to banknotes in each area 201, 202. The clerk can perform the setting by operating the operation unit 10. The control unit 100 stores, in the setting information 113 in the memory 110, the settings of the property right created through the operation unit 10.

The setting may be prepared such that the store has the property right to banknotes in the first area 201 while the CIT company has the property right to banknotes in the second area 202. The setting may be prepared such that the store has the property right to banknotes in both the first area 201 and the second area 202. The setting may be prepared such that the CIT company has the property right to banknotes in both the first area 201 and the second area 202.

The setting may be prepared such that, while the store has the property right to banknotes in the first area 201 and the CIT company has the property right to banknotes in the second area 202, the CIT company has the property right to collection target banknotes out of banknotes stored in the storage unit 130 in the first area 201. In this case, if a collection target banknote is used as a recycle banknote in the dispensing process, it means that the store borrows the banknote from the CIT company. In this case, the control unit 100 changes a recycle banknote in the storage unit 130, which is in the possession of the store, to a collection target banknote, as described for the case of emergency situation with reference to FIGS. 15A and 15B, whereby the borrowed amount of money is returned to the CIT company.

In the present embodiment, the various banknote handling processes that can be performed by the banknote handling apparatus 1 have been described. However, the banknote handling apparatus 1 may not necessarily perform all the banknote handling processes, and may perform some of the banknote handling processes.

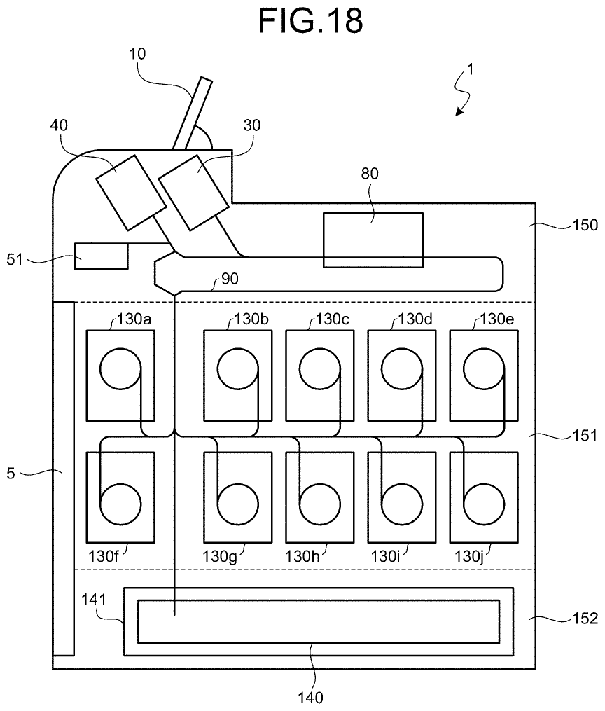

Although the specific configuration of the banknote handling apparatus 1 is shown in FIGS. 1 to 3, these are merely examples. FIG. 18 is a cross-sectional view schematically showing another configuration of the banknote handling apparatus 1. In FIG. 18, the same components as those in FIG. 2 are denoted by the same reference numerals. As shown in FIG. 18, the banknote handling apparatus 1 may have only one reject unit 51, and may not necessarily have a cassette 20 and a rotary unit 60. Each storage unit 130 is not limited to a stacking type storage unit in which banknotes are stacked and stored, and may be a tape-type storage unit in which banknotes are stored while being wound around an outer circumferential surface of a drum together with tapes, and are fed out by reversely rotating the drum. The collection unit 141 may not necessarily store banknotes in a collection bag serving as the collection container 140, and may store banknotes in a cassette detachably mounted to the collection unit 141. The operation unit 10 may not necessarily serve both as an operation unit and a display unit. An operation unit and a display unit may be independent units. The operation unit 10 may not necessarily be included in the banknote handling apparatus 1. For example, a mobile terminal communicably connected to the banknote handling apparatus 1 wirelessly or via a wire may be used as the operation unit 10.

Although the specific examples in which banknotes from sales of the store for two days or four days are stored in the banknote handling apparatus 1 are described, this is merely examples. How many consecutive days over which the banknote handing apparatus 1 can be continuously used while storing therein banknotes from sales for these days, depends on the number of banknotes storable in each storage unit 130, the number of banknotes storable in the collection container 140, the number of banknotes necessary for change for business hours in the store, the number of banknotes from sales, etc. Although the specific example in which banknotes are collected in two collection containers 140 (collection bags) when being collected to outside the banknote handling apparatus 1, this is also an example. The number of collection containers 140 is not particularly limited. The banknotes may be collected in one collection container 140, or three or more collection containers 140 depending on the number of banknotes to be collected and a capacity of the collection containers 140. By repeating the process of dismounting a collection container 140 in which collection target banknotes are stored, and mounting an empty collection container 140 to the collection unit 141 to store, therein, collection target banknotes left in the storage unit 130, the container collection process can be performed regardless of the number of the collection containers 140.

In an exemplary embodiment, the money handling apparatus includes: a depositing unit configured to receive money; a plurality of storage units each configured to store therein the money received in the depositing unit, and feed out the stored money; a collection unit configured to store money in a collection container that is detachably mounted to the collection unit; and a control unit configured to perform a process of storing collection target money, which is to be collected to outside the apparatus, in the collection container and at least one of the storage units.

In the above disclosure, the control unit performs a notification process for notifying the number of collection containers necessary for collecting the collection target money to outside the apparatus.

In the above configuration, the storage units stores therein money including the collection target money and other money that can be discharged to outside the apparatus in a dispensing process. When the quantity of the collection target money stored in one of the storage units becomes equal to or greater than a predetermined quantity, the control unit performs a notification process for notifying an external device that money needs to be collected from the apparatus.

In the above configuration, the storage units starts storing therein the collection target money after the quantity of the collection target money stored in the collection container reaches a maximum quantity of money storable in the collection container.

In the above configuration, the money handling apparatus includes a display unit configured to display, for each denomination, information on the quantity of the collection target money stored in the storage units and information on the quantity of the collection target money stored in the collection container.

In the above configuration, the control unit performs a process for displaying, on the display unit, information for instructing a user to dismount the collection container and mount another collection container.

In the above configuration, in a process for collecting the collection target money to outside the apparatus, after the collection container in which the collection target money having been stored is dismounted from the collection unit and another collection container is mounted to the collection unit, the control unit performs a process for storing, in the mounted collection container, the collection target money which have been stored in the storage units and fed out from the storage units.

In the above configuration, the money handling apparatus further includes a dispensing unit configured to discharge money, which has been fed out from the storage units, to outside the apparatus in a dispensing process. After the amount of money to be collected to outside the apparatus has been determined, the control unit performs a process for transporting the collection target money, which constitutes the determined amount of money, from the storage units to the collection unit and storing the transported collection target money into the collection container. If the collection container becomes full of money while a part of the collection target money remains in the storage units, the control performs a process for keeping the remaining collection target money in the storage units. The control unit performs the dispensing process by using money other than the collection target money out of money stored in the storage units.

In the above configuration, after the amount of proceeds from sales has been determined after business hours of a store, the control unit performs a process for transporting the collection target money, which constitutes the determined proceeds from sales, from the storage units to the collection unit and storing the transported collection target money in the collection container. If the collection container becomes full of money while a part of the collection target money remains in the storage units, the control unit performs a process for keeping the remaining collection target money in the storage units. During business hours on a next day, the dispensing process is performed by using money, of which the quantity is obtained by subtracting the quantity of the collection target money from the quantity of all money, in the storage unit.

In the above configuration, the money handling apparatus further includes a dispensing unit configured to discharge money, which has been fed out from the storage unit, to outside the apparatus in a dispensing process. After the amount of money to be collected to outside the apparatus has been determined, the control unit performs a process for transporting the collection target money, which constitutes the determined amount of money, from the storage units to the collection unit and storing the transported collection target money into the collection container. If the collection container becomes full of money while a part of the collection target money remains in the storage units, the control unit performs a process for changing a usage of at least one of the storage units to a usage as a collection unit and storing the remaining collection target money in the at least one storage unit to be used as the collection unit. The control unit performs the dispensing process by using money stored in storage units other than the at least one storage unit for which the usage has been changed.

In the above configuration, after an amount of proceeds from sales has been determined after business hours of a store, the control unit performs a process for transporting the collection target money, which constitutes the determined proceeds from sales, from the storage units to the collection container and storing the transported collection target money into the collection container. If the collection container becomes full of money while a part of the collection target money remains in the storage units, the control unit performs a process for changing a usage of at least one of the storage units to a usage as a collection unit and storing the remaining collection target money in the at least one storage unit to be used as the collection unit. During business hours on a next day, the dispensing process is performed by using money stored in storage units other than the at least one storage unit for which the usage has been changed.

In an exemplary embodiment, the money handling method includes: receiving money in a depositing unit; storing the money received in the depositing unit, in a plurality of storage units each of which is capable of feeding out the stored money; determining, by a control unit, collection target money to be collected to outside the apparatus; feeding out the collection target money from the storage units, and storing, by a collection unit, the collection target money into a collection container detachably mounted to the collection unit; and keeping at least a part of the collection target money, which remains in the storage units after the collection container becomes full of money, in the storage unit.

In the money handling apparatus, money exceeding the storage capacity of a collection container for collecting money, which is detachably mounted to the money handling apparatus, can be dividedly stored in the collection container and a storage unit that stores and feeds out money to be recycled.

As described above, in the banknote handling apparatus 1 according to the present embodiment, even when the number of collection target banknotes inside the apparatus 1 exceeds the maximum number of banknotes storable in the collection container 140, a part of the collection target banknotes can be stored in at least one storage unit 130 having been used only for storage of recycle banknotes, whereby the banknote handling process including the depositing process and the dispensing process can be continuously performed. The banknote handling apparatus 1 can perform the notification process of notifying the clerk of the store or the person in charge of the CIT company that collection of banknotes is necessary, before the banknote handling process can no longer be continued in the apparatus 1. In the notification process, the number of collection containers 140 necessary for collecting banknotes can be notified. In the banknote handling apparatus 1, when the container collection process of storing banknotes in the collection container 140 to collect these banknotes to outside the apparatus 1 is started, information indicating the banknote collection state can be displayed on the screen of the operation unit 10. A person in charge of the collection work can prepare the necessary number of collection containers 140 in advance, and can smoothly progress the collection work while checking the screen of the operation unit 10.

FIG. 19 is a block diagram of processing circuitry that performs computer-based operations in accordance with the present disclosure. FIG. 19 illustrates processing circuitry 200 of control unit 100, which is a component of money handling apparatus 1.

Processing circuitry 200 is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality. Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality.

In FIG. 19, the processing circuitry 200 includes a CPU 201 which performs one or more of the control processes discussed in this disclosure. The process data and instructions may be stored in memory 202. These processes and instructions may also be stored on a storage medium disk 204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other non-transitory computer readable medium of an information processing device with which the processing circuitry 200 communicates, such as a server or computer. The processes may also be stored in network based storage, cloud-based storage or other mobile accessible storage and executable by processing circuitry 200.

Further, the claimed advancements may be provided as a utility application, background daemon, or component of an operating system, or combination thereof, executing in conjunction with CPU 201 and an operating system such as Microsoft Windows, UNIX, Solaris, LINUX, Apple MAC-OS, Apple iOS and other systems known to those skilled in the art.

The hardware elements in order to achieve the processing circuitry 200 may be realized by various circuitry elements. Further, each of the functions of the above described embodiments may be implemented by circuitry, which includes one or more processing circuits. A processing circuit includes a particularly programmed processor, for example, processor (CPU) 201, as shown in FIG. 19. A processing circuit also includes devices such as an application specific integrated circuit (ASIC) and conventional circuit components arranged to perform the recited functions.

In FIG. 19, the processing circuitry 200 may be a computer or a particular, special-purpose machine. Processing circuitry 200 is programmed to execute processing to control money handling apparatus 1.

Alternatively, or additionally, the CPU 201 may be implemented on an FPGA, ASIC, PLD or using discrete logic circuits, as one of ordinary skill in the art would recognize. Further, CPU 201 may be implemented as multiple processors cooperatively working in parallel to perform the instructions of the inventive processes described above.

The processing circuitry 200 in FIG. 19 also includes a network controller 206, such as an Ethernet PRO network interface card, for interfacing with network 300. As can be appreciated, the network 300 can be a public network, such as the Internet, or a private network such as a local area network (LAN) or wide area network (WAN), or any combination thereof and can also include Public Switched Telephone Network (PSTN) or Integrated Services Digital Network (ISDN) sub-networks. The network 300 can also be wired, such as an Ethernet network, universal serial bus (USB) cable, or can be wireless such as a cellular network including EDGE, 3G and 4G wireless cellular systems. The wireless network can also be Wi-Fi, wireless LAN, Bluetooth, or any other wireless form of communication that is known. Additionally, network controller 206 may be compliant with other direct communication standards, such as Bluetooth, a near field communication (NFC), infrared ray or other.

The processing circuitry 200 further includes a display controller 208, such as a graphics card or graphics adaptor for interfacing with display 209, such as a monitor. An I/O interface 212 interfaces with a keyboard and/or mouse 214 as well as a touch screen panel 216 on or separate from display 109. I/O interface 212 also connects to a variety of peripherals 218.

The storage controller 224 connects the storage medium disk 204 with communication bus 226, which may be an ISA, EISA, VESA, PCI, or similar, for interconnecting all of the components of the processing circuitry 200. A description of the general features and functionality of the display 209, keyboard and/or mouse 214, as well as the display controller 208, storage controller 224, network controller 206, and I/O interface 212 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

As described above, the money handling apparatus and the money handling method according to the present disclosure are useful for, even when the quantity of money to be collected exceeds the storage capacity of a collection container in the apparatus, continuously using the apparatus with the money being stored in the apparatus.

What is claimed is:

1. A money handling apparatus, comprising:
a receptacle that receives money;
a plurality of storage units that each store the money and feed out the stored money;
a collection unit that stores money in a container, the container being detachably mounted to the collection unit; and
control circuitry configured to control storage of collection target money, which is to be collected and removed from the money handling apparatus, in the container and at least one storage unit of the plurality of storage units.

2. The money handling apparatus according to claim 1, wherein the control circuitry is further configured to provide a notification of a number of containers necessary for collecting the collection target money.

3. The money handling apparatus according to claim 1, wherein
the plurality of storage units store the collection target money and other money available for discharge in a dispensing process, and
in a case that a quantity of the collection target money stored in one of the storage units becomes equal to or greater than a predetermined quantity, the control circuitry is configured to provide a notification indicating that money needs to be collected from the money handling apparatus.

4. The money handling apparatus according to claim 1, wherein the plurality of storage units start storing the collection target money after a quantity of the collection target money stored in the container reaches a maximum threshold of money storable in the container.

5. The money handling apparatus according to claim 1, further comprising:
a display configured to display, for each denomination, information indicating a quantity of the collection target money stored in the storage units and information indicating a quantity of the collection target money stored in the container.

6. The money handling apparatus according to claim 5, wherein the control circuitry is further configured to control the display to display information instructing a user to dismount the container from the collection unit and to mount another container to the collection unit.

7. The money handling apparatus according to claim 1, wherein the control circuitry is further configured to control storage, after the container is dismounted from the collection unit and another container is mounted to the collection unit, of the collection target money which have been stored in the storage units and fed out from the storage units into the another container.

8. The money handling apparatus according to claim 1, further comprising:
a dispenser that dispenses money, fed out from the storage units, to outside of the money handling apparatus in a dispensing process, wherein
the control circuitry is further configured to
after an amount of money to be removed from the money handling apparatus is determined, control transport of the collection target money, which constitutes the determined amount of money, from the storage units to the collection unit and control storage of the transported collection target money into the container,
in a case that the container becomes full of money while a part of the collection target money remains in the storage units, perform a process to keep the remaining collection target money in the storage units, and
control the dispenser to perform the dispensing process by using money other than the collection target money out of money stored in the storage units.

9. The money handing apparatus according to claim 1, further comprising:
a dispenser that dispenses money, fed out from the storage units, to outside of the money handling apparatus in a dispensing process, wherein the control circuitry is further configured to
after an amount of proceeds from sales is determined after business hours of a store, control transport of the collection target money, which constitutes the determined proceeds from sales, from the storage units to the collection unit and control storage of the transported collection target money in the container,
in a case that the container becomes full of money while a part of the collection target money remains in the storage units, perform the process to keep the remaining collection target money in the storage units, and
during business hours on a next day, control the dispenser to perform the dispensing process using money, of which a total quantity is obtained by subtracting a quantity of the collection target money from a quantity of all money, in the storage units.

10. The money handling apparatus according to claim 1, further comprising:
a dispenser that dispenses money, fed out from a storage unit, to outside the money handling apparatus in a dispensing process, wherein
the control circuitry is further configured to
after an amount of money to be removed from the money handling apparatus is determined, control transport of the collection target money, which constitutes the determined amount of money, from the storage units to the collection unit and control storage of the transported collection target money into the container,
in a case that the container becomes full of money while a part of the collection target money remains in the storage units, change a usage of at least one of the storage units and control storage of the remaining collection target money in the at least one storage unit, and
control the dispenser to perform the dispensing process by using money stored in storage units other than the at least one storage unit for which the usage has been changed.

11. The money handling apparatus according to claim 1, further comprising:
a dispenser that dispenses money, fed out from a storage unit, to outside the money handling apparatus in a dispensing process, wherein the control circuitry is further configured to
after an amount of proceeds from sales is determined after business hours of a store, control transport of the collection target money, which constitutes the determined proceeds from sales, from the storage units to the container and control storage of the transported collection target money into the container,
in a case that the container becomes full of money while a part of the collection target money remains in the storage units, change a usage of at least one of the storage units and control storage of the remaining collection target money in the at least one storage unit, and
during business hours on a next day, control the dispenser to perform the dispensing process by using money stored in storage units other than the at least one storage unit for which the usage has been changed.

12. A money handling method, comprising:
receiving money through a receptacle of a money handling apparatus;
storing the money received through the receptacle in a plurality of storage units, of the money handling apparatus, that each store money and feed out money;
determining, by control circuitry of the money handling apparatus, collection target money to be removed from the money handling apparatus;
controlling, by the control circuitry, the collection target money to be fed out from the plurality of storage units;
storing the collection target money into a container that is detachably mounted into a collection unit of the money handling apparatus; and
controlling, by the control circuitry, at least a part of the collection target money, which remains in the storage units after the container becomes full of money, to be kept in a storage unit of the plurality of storage units.

13. A money handling apparatus, comprising:
control circuitry configured to:
control storage of money into a plurality of storage units;
determine collection target money to be removed from the money handling apparatus;
control at least a part of the collection target money to be fed out from the plurality of storage units into a container; and
control a remaining part of the collection target money, which remains in the storage units after the container becomes full of money, to be kept in a storage unit of the plurality of storage units.

14. The money handling apparatus according to claim 13, wherein the control circuitry is further configured to output a notification of a number of containers necessary to collect all of the collection target money.

15. The money handling apparatus according to claim 13, wherein
the plurality of storage units store the collection target money and other money available for discharge in a dispensing process, and
in a case that a quantity of the collection target money stored in one of the storage units becomes equal to or greater than a predetermined quantity, the control circuitry is configured to output a notification indicating that money needs to be collected from the money handling apparatus.

16. The money handling apparatus according to claim 13, wherein the plurality of storage units begin to store the collection target money after a quantity of the collection target money stored in the container reaches a maximum threshold of money storable in the container.

17. The money handling apparatus according to claim 13, further comprising:
a display configured to display, for each denomination, information indicating a quantity of the collection target money stored in the storage units and information indicating a quantity of the collection target money stored in the container.

18. The money handling apparatus according to claim 17, wherein the control circuitry is further configured to control the display to display information instructing a user to dismount the container from the money handling apparatus and to mount another container to the collection unit.

19. The money handling apparatus according to claim 13, wherein the control circuitry is further configured to control storage, after the container is dismounted from the money handling apparatus and another container is mounted to the money handling apparatus, of the collection target money which have been stored in the storage units and fed out from the storage units into the another container.

20. The money handling apparatus according to claim 13, further comprising:
a dispenser that dispenses money, fed out from the storage units, to outside of the money handling apparatus in a dispensing process, wherein
the control circuitry is further configured to
after an amount of money to be removed from the money handling apparatus is determined, control transport of the collection target money from the storage units into the container,
in a case that the container becomes full of money while a part of the collection target money remains in the storage units, perform a process to keep the remaining collection target money in the storage units, and
control the dispenser to perform the dispensing process by using money other than the collection target money out of money stored in the storage units.
